(19) United States
(12) Patent Application Publication
(10) Pub. No.: US 2005/0254360 A1
(43) Pub. Date: Nov. 17, 2005

(54) Focus control method for optical disk device

(75) Inventors: Toshihisa Sameshima, Kyoto (JP); Kazuhiro Takeshita, Osaka (JP); Hisashi Sugibuchi, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/116,236

(22) Filed: Apr. 28, 2005

(30) Foreign Application Priority Data
May 17, 2004 (JP) 2004-146845

(51) Int. Cl. G11B 7/00

(52) U.S. Cl. 369/44.23; 369/44.27; 369/44.34

(57) ABSTRACT

The focus control method of the present invention includes: rotating an optical disk; driving an optical pickup upward and downward vertically to the optical disk at timing of a signal pulse detecting the rotational angle of the optical disk; detecting a focus drive value at timing at which the focal point of a light beam is located on a recording surface of the optical disk; computing a vertical deviation amount from focus drive values at three or more detection points per rotation; applying in advance the vertical deviation amount for a given rotational angle detection signal pulse as the focus drive value; and performing focus control at the given rotational angle detection signal pulse.

### CROSS-REFERENCE TO RELATED APPLICATIONS

This application claims priority under 35 U.S.C. §119 on Patent Application No. 2004-146845 filed in Japan on May 17, 2004, the entire contents of which are hereby incorporated by reference.

### BACKGROUND OF THE INVENTION

The present invention relates to an optical disk device, and more particularly to a stable focus control method for an optical disk device.

An example of construction of an optical disk device will be described with reference to FIG. 1. Referring to FIG. 1, the optical disk device includes an optical pickup 2, a disk motor 3, a tangential tilt drive means 4, a radial tilt drive means 5, a focus drive means 6, a tracking drive means 7, a traverse motor 8, a traverse drive means 9, a disk motor drive means 10, a signal generation means 11, a playback signal decode means 13, a mechanical servo means 16, a system control means 18 and a program storage means 19.

An optical disk 1 is rotated with the disk motor 3 that is driven with the disk motor drive means 10. An FG signal 15 representing the rotational angular velocity is output with rotation of the disk motor 3. Based on the FG signal 15, the mechanical servo means 16 performs servo computation and outputs a control instruction signal 17, to thereby control the rotational angular velocity of the optical disk 1 via the disk motor drive means 10.

A light beam is emitted from the optical pickup 2 to the optical disk 1. The optical pickup 2 is driven in directions vertical to the optical disk 1 with the focus drive means 6. Once the focal point of the light beam is located on a recording surface of the optical disk 1, the signal generation means 11 generates a focus error signal as a kind of servo error signal 14. Using the focus error signal, the mechanical servo means 16 performs servo computation and outputs the control instruction signal 17, to thereby perform focus control in which the distance between the optical disk 1 and the optical pickup 2 is kept roughly constant via the focus drive means 6 to bring the light beam into focus.

In the state that the light beam is in focus, the signal generation means 11 generates a tracking error signal as a kind of servo error signal 14. Using the tracking error signal, the mechanical servo means 16 performs servo computation and outputs the control instruction signal 17, to thereby perform tracking control in which the tracking drive means 7 is driven in the radial direction of the optical disk so that the light beam can follow a track of the optical disk on which information is recorded.

When the optical disk is rotated during the tracking control, the optical pickup 2 follows the track and thus is gradually moved toward the outer circumference of the optical disk 1. The tracking coverage of the optical pickup 2 is small compared with the number of tracks in the radial direction of the optical disk 1. Therefore, once the optical pickup 2 crosses a given boundary set within the tracking coverage, the mechanical servo means 16 outputs the control instruction signal 17 to move the traverse drive means 9 toward the outer circumference, to thereby perform traverse control in which the lens of the optical pickup 2 is allowed to be near the center of the tracking coverage.

The optical pickup 2 is provided with the tangential tilt drive means 4 as a means of correcting a tilt of the optical disk 1 in a tangential direction and the radial tilt drive means 5 as a means of correcting a tilt of the optical disk 1 in the radial direction, so that a tilt of the plane of the optical disk 1 can be controlled with the control instruction signal 17 output from the mechanical servo means 16.

With the tracking control, data recorded on the optical disk 1 becomes readable, which is output as playback data 12 by the signal generation means 11 and then converted to final data by the playback data decode means 13. The system control means 18 instructs the mechanical servo means 16 and the playback data decode means 13 to start there operations sequentially with timing according to execution instructions stored in the program storage means 19.

Examples of prior art focus control will be described based on the construction of the optical disk device shown in FIG. 1.

As prior art 1, a focus control method disclosed in Japanese Laid-Open Patent Publication No. 2001-155351 will be described. Specifically, a conventional method for starting focus control for an optical disk having a vertical deviation will be described with reference to FIG. 35. In FIG. 35, an amount equivalent of a vertical deviation (vertical deviation amount) 20 of an optical disk is shown. In most cases, the vertical deviation amount 20 is in the shape of a sine wave of which one period is output in one rotation of the optical disk. To start focus control, focus drive 22 is made in a direction closer to the optical disk (upward in the case of FIG. 35), which is output as the focus drive value. A one-period sine wave (hereinafter, referred to as an S-shaped signal) is given to a focus error signal (FE signal) 25 at timing of each crossing between the focus drive value and the vertical deviation signal (timing at which the focal point of a light beam output from the optical pickup is located on a recording surface of the optical disk). The gradient of the change in focus drive value with time is made steep until the first S-shaped signal is output, to shorten the pull-in time. Once the S-shaped signal is detected, the gradient of the change in focus drive value with time is made mild, so that the optical pickup is moved mildly in a direction farther from the optical disk to thereby detect a vertical deviation bottom point 76. From the detected vertical deviation bottom point, the gradient of the change in focus drive value with time is shifted to an obtuse angle in a direction toward the optical disk. With the mild gradient of the change in focus drive value with time, focus control is started (focus ON 28) in the neighborhood of the vertical deviation bottom point (a portion slow in the acceleration of the amount of change in vertical deviation with the rotation), to thereby attain correct focus pulling.

As prior art 2, a method for measuring the vertical deviation amount disclosed in Japanese Laid-Open Patent Publication No. 2001-307341 will be described. Specifically, conventional focus control for a multilayer optical disk will be described with reference to FIG. 36. FIG. 36 shows a vertical deviation amount 44 of a dual-layer optical disk as an example of multi-layer disks. In the dual-layer disk, also, as in the case of the prior art 1 described above, the vertical deviation amount 44 is supposed to be in the shape of a sine wave of which one period is output in one rotation of the optical disk in many cases. Because the dual-layer optical disk has two recording surfaces, two parallel sine waves are output. In the case of FIG. 36, an FG signal 21 outputs six pulses in one rotation of the optical disk. The vertical deviation amount of the optical disk is measured during rotation of the optical disk and under operation of focus control. That is, the focus drive value is detected in synchronization with the pulses of the FG signal 21, to thereby measure the vertical deviation amount. The measured vertical deviation amount of the optical disk is used for focus jumping for shifting the focal point of the optical beam from a given layer of the multilayer optical disk to another given layer thereof. The acceleration with which the optical pickup is moved to the optical disk is computed from the vertical deviation amount in one rotation of the optical disk. When the computed acceleration is smaller than a given set value, focus jumping 54 is performed.

As prior art 3, a method for detecting a multilayer optical disk disclosed in Japanese Laid-Open Patent Publication No. 10-312629 will be described. That is, a conventional method for detecting a multilayer optical disk will be described with reference to FIG. 37. FIG. 37 shows a vertical deviation amount 44 of a dual-layer optical disk as an example of multilayer disks. While focus drive 22 is made upwardly as is viewed from FIG. 37 to move the optical pickup closer to a recording surface of the optical disk, S-shaped signals of an FE signal 25 are output at the timing of crossings between the focus drive value and the vertical deviation signals (timing at which the focal point of the light beam output from the optical pickup is located on the recording surfaces of the optical disk). The number of layers of the optical disk is determined by counting (77) the number of S-shaped signals of the FE signal 25. In the example shown in FIG. 37, the number of S-shaped signals is double that in the case of a single-layer disk.

The above conventional techniques have the following problems.

In the prior art 1, to correctly find the vertical deviation bottom point of an optical disk, the gradient of the change in focus drive value with time is made mild. Hence, the focus control is only started after the optical disk has rotated two or more times, and thus it takes a long time to start the focus control.

In the prior art 2, it is necessary to start focus control to detect the vertical deviation amount of an optical disk. Hence, in the case of an optical disk having a large vertical deviation amount, in particular, the focus control itself may fail.

In the prior art 3, in which the number of S-shaped signals of the FE signal is merely counted, determination may be wrong if a false waveform (pseudo-signal) is input.

### SUMMARY OF THE INVENTION

The focus control method of the present invention is a focus control method for an optical disk device, the optical disk device including:
focus drive means for moving an optical pickup in a direction vertical to a recording surface of an optical disk, the optical pickup irradiating the optical disk with a converged light beam for playback of the optical disk and having a plurality of light receiving elements for receiving reflected light from the optical disk and converting the received light to an electric signal;
spindle drive means for rotating the optical disk;
rotational angular velocity detection means for detecting the rotational angular velocity from an FG signal detecting the rotational angle of the optical disk rotated by the spindle drive means;
focus position detection means for detecting that the focal point of the converted light beam is located on a recording surface of the optical disk;
focus drive value detection means for detecting a drive value output from the focus drive means at given timing;
focus detection time measurement means for measuring the time difference between a given edge of the FG signal detecting the rotational angular velocity of the optical disk and the timing of the detection of the focus position by the focus position detection means;
vertical deviation computation means for computing a vertical deviation amount for each FG signal pulse in one rotation of the optical disk using the focus drive value obtained by the focus drive value detection means and the measured result obtained by the focus detection time measurement means; and
vertical deviation amount storage means for storing the vertical deviation amount of the optical disk obtained by the vertical deviation computation means in association with an edge of the corresponding FG signal pulse,
the focus control method including the steps of:
performing focus up/down drive for the optical pickup, while rotating the optical disk, at timing of a given edge of the FG signal detecting the rotational angular velocity three or more times in one rotation, the focus up/down drive including driving the optical pickup in directions vertical to the optical disk to be closer to and then farther from the optical disk, or to be farther from and then closer to the optical disk, in a sequential pattern;
detecting the focus drive value at focus timing at which the focal point of the light beam is located on a recording surface of the optical disk;
measuring a focus detection time as the time difference between the timing of the given edge of the FG signal and the focus timing;
computing the vertical deviation amount in one rotation of the optical disk using the focus drive value at the focus timing and the focus detection time; storing the computed vertical deviation amount; and
performing focus control according to the stored vertical deviation amount so that the focal point of the light beam is roughly located on the recording surface of the optical disk.

According to the focus control method described above, the amount of change in vertical deviation with time with rotation of the optical disk can be detected in association with edges of the FG signal before start of the focus control. Hence, more stable focus control according to the detected amount of change in vertical deviation can be attained.

Alternatively, the focus control method of the present invention is a focus control method for an optical disk device, the optical disk device including:
focus drive means for moving an optical pickup in a direction vertical to a recording surface of an optical disk, the optical pickup irradiating the optical disk with a converged light beam for playback of the optical disk and having a plurality of light receiving elements for receiving reflected light from the optical disk and converting the received light to an electric signal;
spindle drive means for rotating the optical disk;
rotational angular velocity detection means for detecting the rotational angular velocity from an FG signal detecting the rotational angle of the optical disk rotated by the spindle drive means;
focus position detection means for detecting that the focal point of the converted light beam is located on a recording surface of the optical disk;
focus drive value detection means for detecting a drive value output from the focus drive means at given timing;
focus detection time measurement means for measuring the time difference between a given edge of the FG signal detecting the rotational angular velocity of the optical disk and the timing of the detection of the focus position by the focus position detection means;
vertical deviation computation means for computing a vertical deviation amount for each FG signal pulse in one rotation of the optical disk using the focus drive value obtained by the focus drive value detection means and the measured result obtained by the focus detection time measurement means; and
vertical deviation amount storage means for storing the vertical deviation amount of the optical disk obtained by the vertical deviation computation means in association with an edge of the corresponding FG signal pulse,
the focus control method including the steps of:
changing the focus drive value at timing of a given edge of the FG signal with a given amount of change with time in a direction allowing the optical pickup to be closer to the optical disk;
holding the focus drive value once the focus drive value reaches a given set value until the next edge of the FG signal;
changing the focus drive value at timing of the next edge of the FG signal with a given amount of change with time in a direction allowing the optical pickup to be farther from the optical disk;
holding the focus drive value once the focus drive value reaches a given set value until the further next edge of the FG signal;
performing the above steps alternately thereafter at timing of edges of the FG signal, to detect the vertical deviation amount of the optical disk from the focus drive values detected at the focus positions in association with the corresponding edges of the FG signal; and
performing focus control according to the detected vertical deviation amount.

According to the focus control method described above, the number of times of detection of the vertical deviation amount per rotation of the optical disk can be increased. Hence, the vertical deviation amount of the optical disk can be detected more correctly.

Yet another control method of the present invention is a focus control method for an optical disk device, the optical disk device including:
focus drive means for moving an optical pickup in a direction vertical to an optical disk, the optical pickup irradiating the optical disk with a converged light beam and having a plurality of light receiving elements for receiving reflected light from the optical disk and converting the received light to an electric signal;
spindle drive means for rotating the optical disk;
rotational angular velocity detection means for detecting the rotational angular velocity from an FG signal detecting the rotational angle of the optical disk rotated by the spindle drive means;
focus summation signal maximum detection means for determining the maximum of a focus summation signal obtained by summing a plurality of signals obtained from the plurality of light receiving elements of the optical pickup;
focus summation signal time measurement means for measuring the time during which the focus summation signal is greater than a given value;
focus error extreme detection means for determining the maximum and minimum of a focus error signal representing a difference in the distance between the focal point of the light beam and a recording surface of the optical disk;
focus error extreme shift time measurement means for measuring the time of the shift of the focus error signal from the maximum to the minimum or the time of the shift from the minimum to the maximum;
RF envelope signal maximum detection means for detecting the maximum of an RF envelope signal for holding an amplitude value of an RF signal made of a plurality of frequencies including information recorded on the optical disk,
RF envelope signal time measurement means for measuring the time during which the RF envelope signal is greater than a given value;
focus position detection means for detecting that the focal point of the converted light beam is located on a recording surface of the optical disk;
vertical deviation change rate detection means for detecting the relative rate of the amount of change with time in the vertical deviation amount changing with rotation of the optical disk to the amount of change with time in the focus drive value output from the focus drive means at given timing using at least one of the focus summation signal time measurement means, the focus error extreme shift time measurement means and the RF envelope signal maximum detection means;
focus drive value detection means for detecting the drive value output from the focus drive means at given timing;
focus position detection time measurement means for measuring the time difference between a given edge of the FG signal used in the rotational angular velocity detection means and the timing of the detection of the focus position by the focus position detection means;
vertical deviation computation means for computing a vertical deviation amount for each FG signal pulse in one rotation of the optical disk using the focus drive value obtained by the focus drive value detection means, the output from the vertical deviation change rate detection means and the result obtained by the focus position detection time measurement means; and
vertical deviation amount storage means for storing the vertical deviation amount of the optical disk obtained by the vertical deviation computation means in association with edges of the FG signal,
the focus control method including the steps of:
performing focus up/down drive for the optical pickup, while rotating the optical disk, at timing of a given FG signal pulse output in synchronization with the rotation of the optical disk two or more times per rotation, the focus up/down drive including driving the optical pickup in directions vertical to the optical disk to be closer to and then farther from the optical disk, or to be farther from and then closer to the optical disk, in a sequential pattern;
detecting the focus drive value at focus timing at which the focal point of the light beam is located on a recording surface of the optical disk and also detecting the vertical deviation change rate with rotation of the optical disk at detection timing of the focus position detected during at least one sequential operation among the two or more times of the focus up/down drive;
computing the vertical deviation amount in one rotation of the optical disk using the time difference between the timing of a given edge of the FG signal and the focus timing;
storing the computed vertical deviation amount; and
performing focus control according to the stored vertical deviation amount so that the focal point of the light beam is roughly located on the recording surface of the optical disk.

According to the focus control method described above, not only the focus drive value for the vertical deviation amount detected at one time but also the difference between the amount of change in focus drive value with time and the amount of change in vertical deviation are computed. This can reduce power consumption in detection of the vertical deviation amount.

Yet another method of the present invention is a focus control method for an optical disk device, the optical disk device including:
focus drive means for moving an optical pickup in a direction vertical to a recording surface of an optical disk, the optical pickup irradiating the optical disk with a converged light beam and having a plurality of light receiving elements for receiving reflected light from the optical disk and converting the received light to an electric signal; and
focus error polarity detection means for detecting whether an S-shaped signal of a focus error signal output when the focal point of the light beam passes through a recording surface of the optical disk changes from the maximum to the minimum or from the minimum to the maximum,
the focus control method including the steps of:
driving the optical pickup in a direction vertical to the optical disk to be closer to or farther from the optical disk;
detecting the polarity of the S-shaped signal of the focus error signal generated when the focal point of the light beam passes through a recording surface of the optical disk; and
determining the number of recording surfaces of the optical disk from the polarity of a given number of S-shaped signals of the focus error signal detected.

According to the focus control method described above, the number of recording surfaces of the optical disk can be determined by a simple method in a short time.

In the focus control method described above, preferably, the optical disk device further includes:
focus summation signal maximum detection means for determining the maximum of a focus summation signal obtained by summing a plurality of signals obtained from the plurality of light receiving elements of the optical pickup;
focus error extreme detection means for determining the maximum and minimum of the focus error signal representing a difference in the distance between the focal point of the light beam and a recording surface of the optical disk;
RF envelope signal maximum detection means for detecting the maximum of a signal for holding a peak value of an RF signal made of a plurality of frequencies including data recorded on the optical disk;
spindle drive means for rotating the optical disk;
rotational angular velocity detection means for detecting the rotational angular velocity from an FG signal detecting the rotational angle of the optical disk rotated by the spindle drive means;
focus drive value detection means for detecting a focus drive value output from the focus drive means at given timing;
focus position detection time measurement means for measuring the time difference between a given edge of the FG signal used in the rotational angular velocity detection means and the timing of the detection of the focus position by the focus position detection means;
vertical deviation computation means for computing a vertical deviation amount for each FG signal pulse in one rotation of the optical disk using the focus drive value obtained by the focus drive value detection means and the result obtained by the focus position detection time measurement means; and
vertical deviation amount storage means for storing the vertical deviation amount of the optical disk obtained by the vertical deviation computation means in association with edges of the FG signal, and
the focus control method further includes the steps of:
performing focus up/down drive for the optical pickup, while rotating the optical disk, at timing of a given edge of the FG signal three or more times per rotation, the focus up/down drive including driving the optical pickup in directions vertical to the optical disk to be closer to and then farther from the optical disk in a sequential pattern;
computing the vertical deviation amount for each detected recording surface using the focus drive value detected at the focus timing at which the focal point of the optical beam is located on a recording surface of the optical disk and the time difference between the timing of the given edge of the FG signal and the focus timing;
storing the computed vertical deviation amount in association with edges of the FG signal; and performing focus control for each layer using the stored value.

According to the focus control method described above, the vertical deviation amount can be easily set according to the determined number of layers of the optical disk.

In the focus control method described above, preferably, the optical disk device further includes:
focus S-shaped signal count means for detecting the number of S-shaped signals of the focus error signal generated when the focal point of the light beam passes through a recording surface of the optical disk, and
the focus control method further includes the steps of:
performing focus up/down drive including driving the focus drive means to be closer to and then farther from the optical disk in a sequential pattern a given number of times per rotation;
detecting the focus drive value at timing of the first detection of a recording surface when the number of S-shaped signals having the same polarity detected in the first focus up/down drive is two or more;
detecting the difference in focus drive value between a plurality of layers of the optical disk at the second detection;
detecting the focus drive value only for a given layer of the optical disk at timing of the subsequent detections of a recording surface; and
performing focus control for each layer by adding or subtracting the difference in focus drive value between layers to or from the detected vertical deviation amount for the given layer.

According to the focus control method described above, it is unnecessary to secure the means for storing the vertical deviation amount for each layer in playback of an optical disk having a plurality of layers, and thus cost reduction can be attained.

In the focus control method described above, preferably, the optical disk device further includes:
focus S-shaped signal amplitude detection means for detecting the amplitude of an S-shaped signal of the focus error signal from the difference between the maximum and minimum of the S-shaped signal, and
the focus control method further includes the steps of:
executing addition/subtraction of a given set value, not detecting the focus drive value if a plurality of S-shaped signals having the same polarity are output continuously in the focus error signal and the amplitude of a detected S-shaped signal is smaller than a given set value; and
performing focus control for each layer using the computed value.

According to the focus control method described above, a measurement error that may occur if the vertical deviation amount is detected under the condition that reflected light from a given layer is small due to a flow and the like on the optical disk, for example, can be suppressed, and thus stable detection of the vertical deviation amount is ensured.

In the focus control method described above, preferably, the optical disk device further includes:
spindle drive means for rotating the optical disk;
rotational angular velocity detection means for detecting the rotational angular velocity from an FG signal detecting the rotational angle of the optical disk rotated by the spindle drive means;
focus position detection means for detecting that the focal point of the converted light beam is located on a recording surface of the optical disk;
focus drive value detection means for detecting a drive value output from the focus drive means at given timing;
focus detection time measurement means for measuring the time difference between a given edge of the FG signal at which the rotational angular velocity of the optical disk is detected and the timing of the detection of the focus position by the focus position detection means;
vertical deviation computation means for computing a vertical deviation amount for each FG signal pulse in one rotation of the optical disk using the focus drive value obtained by the focus drive value detection means and the measured result obtained by the focus detection time measurement means; and
vertical deviation amount storage means for storing the vertical deviation amount of the optical disk obtained by the vertical deviation computation means in association with a corresponding FG signal edge,
the focus control method further includes the steps of:
outputting, as the focus drive value, such a signal that updates a focus drive value corresponding to the vertical deviation amount computed and stored for each edge of the FG signal output according to the rotational angular velocity of the optical disk, every edge of the FG signal.

According to the focus control method described above, the focal point of the light beam can be kept near a recording surface of the optical disk, to enable start of the focus control at timing of an edge of the FG signal.

In the focus control method described above, preferably, the optical disk device further includes:
spindle drive means for rotating the optical disk;
rotational angular velocity detection means for detecting the rotational angular velocity from an FG signal detecting the rotational angle of the optical disk rotated by the spindle drive means;
focus position detection means for detecting that the focal point of the converted light beam is located on a recording surface of the optical disk;
focus drive value detection means for detecting a drive value output from the focus drive means at given timing;
focus detection time measurement means for measuring the time difference between a given edge of the FG signal at which the rotational angular velocity of the optical disk is detected and the timing of the detection of the focus position by the focus position detection means;
vertical deviation computation means for computing a vertical deviation amount for each FG signal pulse in one rotation of the optical disk using the focus drive value obtained by the focus drive value detection means and the measured result obtained by the focus detection time measurement means; and
vertical deviation amount storage means for storing the vertical deviation amount of the optical disk obtained by the vertical deviation computation means in association with a corresponding FG signal edge, and
the focus control method further includes the steps of:
outputting a focus drive value corresponding to the vertical deviation amount computed and stored for each edge of the FG signal output according to the rotational angular velocity of the optical disk, in a form approximated to a sine wave over a given FG signal pulse and the next FG signal pulse.

According to the focus control method described above, the focal point of the light beam can be kept near a recording surface of the optical disk irrespective of the timing of edges of the FG signal. Hence, the focus control can be started stably at given timing irrespective of the timing of the edges of the FG signal.

The focus control method described above preferably further includes the step of:
changing the amount of change in focus drive value per unit time with the length of time between edges of the FG signal.

According to the focus control method described above, the vertical deviation amount can be detected reliably even when the period of the FG signal is not constant, such as during acceleration of the rotation of the optical disk in startup, for example.

The focus control method described above preferably further includes the steps of:
performing the focus drive for the optical pickup in a direction vertical to the optical disk to be closer to the optical disk; and
setting the amount of change in focus drive value per unit time and the amount of change in focus drive value per unit time in driving of the optical pickup farther from the optical disk, at individual given values.

According to the focus control method described above, wasted time involving no vertical deviation detection is minimized to shorten the time of detecting the vertical deviation of the optical disk, and the gradient of the amount of change in focus drive value with time is made mild during the vertical deviation detection. Hence, the precision of the vertical deviation detection can be improved.

The focus control method described above preferably further includes the steps of:
computing and storing the vertical deviation amount associated with edges of the FG signal during one rotation of the optical disk;
setting the focus drive value stored for a given edge of the FG signal as the focus drive value in advance before the given edge of the FG signal; and
starting the focus control at timing of the given edge of the FG signal.

According to the focus control method described above, the focus control can be started stably irrespective of the vertical deviation amount of the optical disk or the amount of change in vertical deviation amount per unit time.

The focus control method described above preferably further includes the steps of:
computing and storing the vertical deviation amount associated with edges of the FG signal during one rotation of the optical disk;
setting the amount of change in the focus drive value output from the focus drive means per unit time to be mildly approximated to the amount of change in focus drive value per unit time stored for a given edge of the FG signal; and
starting focus control at timing of the given edge of the FG signal.

According to the focus control method described above, the focus control can be started further stably since the difference between the amount of change in vertical deviation amount with time immediately before start of the focus control and the amount of change in focus drive value with time is small.

In the focus control method described above, preferably, the optical disk device further includes:
focus control drive value detection means for detecting the focus drive value for each FG signal pulse while performing focus control for keeping the distance between the focal point of the light beam and a recording surface of the optical disk constant, and
the method further includes the steps of:
determining whether or not the difference between the focus drive value corresponding to the vertical deviation amount of the optical disk computed and stored before the focus control and the focus drive value corresponding to the vertical deviation amount of the optical disk detected during the focus control is greater than a given set value; and
performing subsequent focus control using the vertical deviation amount detected during the focus control if the difference between the vertical deviation amount detected before the focus control and the vertical deviation amount detected during the focus control is greater than the given set value.

According to the focus control method described above, the vertical deviation amount can be detected further correctly by compensating an error in vertical deviation amount detected before start of the focus control with more correct vertical deviation information obtained after start of the focus control.

In the focus control method described above, preferably, the optical disk device further includes:
focus jump means for outputting an acceleration signal or a deceleration signal for shifting the focal point of the light beam from a given layer to a layer other than the given layer in playback of an optical disk having a plurality of layers, a given peak value and a given drive time of the acceleration signal or the deceleration signal being set by the focus drive means, and
the method further includes the step of:
changing at least one of the peak value and the drive time of at least one of the acceleration signal and the deceleration signal in the focus jump means according to the vertical deviation amount of the optical disk computed and stored for each edge of the FG signal.

According to the focus control method described above, focus jumping can be performed stably irrespective of the vertical deviation amount of the optical disk.

The focus control method described above preferably further includes the step of:
setting the focus drive value so that the amount of change in focus drive value per unit time is mildly approximated to the amount of change in vertical deviation per unit time with rotation of the optical disk computed for each edge of the FG signal, before start of the focus control for a given layer of the optical disk having a plurality of layers, to which the optical pickup has been moved by the focus jump means.

According to the focus control method described above, the stability of the focus jumping according to the vertical deviation can be improved.

The focus control device described above preferably further includes the steps of:
suspending the focus control temporarily when the optical pickup is moved from a given layer to a layer other than the given layer for playback of an optical disk having a plurality of layers;
setting the focus drive value for a given edge of the FG signal according to the vertical deviation amount of the optical disk computed and stored for each edge of the FIG signal for the destination layer; and
restarting the focus control for the destination layer at timing of the given edge of the FG signal.

According to the focus control method described above, the focus control for a given layer after the focus jumping can be started stably with high speed without use of the focus error signal.

In the focus control method described above, preferably, the optical disk device further includes:
vertical deviation change amount computation means for computing the amount of change in focus drive value per unit time with rotation of the optical disk from the vertical deviation amount of the optical disk computed and stored for each edge of the FG signal, and
the method further includes the steps of:
computing the timing of an edge of the FG signal at which the amount of change in the vertical deviation amount of the optical disk per unit time is equal to or less than a given value; and
starting the focus control at the timing of the computed edge of the FG signal.

According to the focus control method described above, the focus control is started at a position small in the change in vertical deviation amount with time, and this ensures more stable start of the focus control.

The focus control method described above preferably further includes the step of:
performing focus jumping of moving the optical pickup from a given layer to a layer other than the given layer when the amount of change in vertical deviation amount per unit time is smaller than a given value in playback of an optical disk having a plurality of layers.

According to the focus control method described above, the focus jumping is performed at a position small in the amount of change in vertical deviation amount with time, and this ensures more stable control of the focus jumping.

In the focus control method described above, preferably, the optical disk device further includes:
optical pickup moving means for moving the optical pickup in the radial direction of the optical disk, and
the method includes the steps of:
moving the optical pickup to the innermost radial position of the optical disk;
performing focus up/down drive for the optical pickup in a direction vertical to the optical disk to be closer to or farther from the optical disk at the innermost radial position of the optical disk;
detecting the focus drive value at timing at which the focal point of the light beam is located on a recording surface of the optical disk;
moving the optical pickup to a given position by the optical pickup moving means;
detecting the vertical deviation amount for each edge of the FG signal at the destination position;
detecting the focus drive value corresponding to the detected vertical deviation amount; and
computing the vertical deviation amount for each edge of the FG signal with respect to the position of the optical pickup in the radial direction.

According to the focus control method described above, the vertical deviation amount of the optical disk varying with the position of the optical pickup in the radial direction is detected. Hence, stable focus control can be performed at any position on the optical disk.

In the focus control method described above, preferably, the optical disk device further includes:
track crossing detection signal for detecting that the focal point of the light beam has crossed a track of the optical disk on which information has been recorded, and
the method further includes the steps of:
moving the optical pickup in the radial direction of the optical disk; and
computing the vertical deviation amount of the optical disk in the radial direction for each edge of the FG signal using a track crossing signal.

According to the focus control method described above, the vertical deviation amount at the destination of the optical pickup can be computed more correctly.

The focus control method described above preferably further includes the steps of:
moving the optical pickup in the radial direction of the optical disk; and computing the vertical deviation amount of the optical disk in the radial direction for each edge of the FG signal from the address of the destination to which the optical pickup is moved.

According to the focus control method described above, the vertical deviation amount at the destination of the optical pickup can be computed in a simpler manner.

The focus control method described above preferably further includes the steps of:
moving the optical pickup in the radial direction of the optical disk;
detecting the focus drive value while performing the focus control for each edge of the FG signal; and
computing the vertical deviation amount of the optical disk in the radial direction using the detected value.

According to the focus control method described above, the vertical deviation amount in the radial direction of the optical disk can be detected during movement of the optical pickup, and thus, from the detection result, the vertical deviation amounts in the radial direction and tangential direction of the optical disk can be computed simultaneously with high speed.

In the focus control device described above, preferably, the optical disk device further includes:
tangential tilt drive means for operating to change a tilt of the optical pickup in the circumferential direction of the optical disk; and
radial tilt drive means for operating to change a tilt of the optical pickup in the radial direction of the optical disk, and
the method further includes the steps of:
computing a tilt amount of the optical disk in the rotational direction or the radial direction at a given position of the optical pickup in the radial direction at a given edge of the FG signal;
changing the drive value of at least either the tangential tilt drive means or the radial tilt drive means based on the computed value; and
performing the focus control.

According to the focus control method described above, the tilt in the radial direction or tangential direction occurring due to a vertical deviation of the optical disk is corrected before start of the focus control. Hence, the focus control can be started stably.

The focus control method described above preferably further includes the steps of:
computing the timing of an edge of the FG signal at which the tilt amount of the optical disk in the circumferential direction or the radial direction is smaller than a given set value, from the vertical deviation amount of the optical disk detected and stored for each edge of the FG signal or for each position in the radial direction; and
starting the focus control at the computed edge of the FG signal.

According to the focus control method described above, the focus control is started or the focus jumping is performed at a position small in the tilt amount in the radial or tangential direction, and this ensures stable focus control or focus jumping.

In the focus control method described above, preferably, the optical disk device further includes:
focus control gain change means for changing a focus control gain; and
optical disk playback speed change means for changing the playback speed of the optical disk, and
the method further includes the steps of:
determining whether or not the difference between the maximum and minimum of the detected and stored vertical deviation amount of the optical disk is greater than a given set value; and
at least increasing the focus control gain in the focus control or decreasing the playback speed of the optical disk if the difference is determined greater.

According to the focus control method described above, the peak value of the vertical deviation amount detected before start of the focus control is obtained. If the peak value is greater than a given set value, the playback speed of the optical disk is reduced, or the control gain of the focus control is increased, and then the focus control is performed.

The focus control method described above preferably further includes the steps of:
performing focus up/down drive for the optical pickup once at timing of a given edge of the FG signal while rotating the optical disk when the operation of the device is temporarily suspended and the second and subsequent startups are performed without changing the optical disk; and
associating the focus drive value at the detected focus position with the stored vertical deviation amount for each edge of the FG signal.

According to the focus control method described above, in the second and subsequent startups involving no disk removal, the vertical deviation amount detected and stored in the first startup is allocated to given FG signal pulses based on the position of a recording surface of the optical disk obtained when the optical pickup is driven once in a direction vertical to the optical disk and the amount of change in vertical deviation amount with time.

In the focus control method described above, preferably, the optical disk device further includes;
address vertical deviation detection means for associating the vertical deviation amount of the optical disk detected and stored for each edge of the FG signal with an address read from the optical disk, and the method further includes the steps of:
associating the vertical deviation amount with address information acquired from the optical disk when the operation of the device is temporarily suspended and the second and subsequent startups are performed without changing the optical disk; and
performing the focus control using the focus drive amount corresponding to the associated vertical deviation amount.

According to the focus control method described above, the vertical deviation amount of the optical disk associated with the FG signal pulses is associated with address information of the optical disk. In the second and subsequent playback involving no disk removal, when the address of the optical disk is acquired after start of the focus control, the associated vertical deviation amount is used to perform the subsequent focus control.

The focus control method described above preferably further includes the steps of:
selecting a vertical deviation amount associated with a given edge of the FG signal, among the vertical deviation amount detected and stored in association with edges of the FG signal during first startup, when operation of the device is temporarily suspended and the second and subsequent startups are performed without changing the optical disk;
applying a focus drive amount corresponding to the selected vertical deviation amount to the optical pickup;
detecting a focus drive value at focus timing at which the focal point of the light beam is located on a recording surface of the optical disk detected during rotation of the optical disk; and
associating the detected focus drive value with the stored vertical deviation amount for each edge of the FG signal.

According to the focus control method described above, a focus drive value corresponding to the vertical deviation amount at a given FG pulse, among the vertical deviation amount detected and stored in association with FG signal pulses at the first startup, is applied at the second and subsequent startups involving no disk removal. The amount of change in vertical deviation amount with time is allocated to the FG signal pulses based on the vertical deviation position of the optical disk detected with rotation of the optical disk and the amount of change in vertical deviation amount with time, and then the subsequent focus control is performed. Hence, the second and subsequent startup times involving no disk removal can be shortened in a simply way without wasteful power consumption.

### BRIEF DESCRIPTION OF THE DRAWINGS

FIG. 1 is a view showing a construction of an optical disk device.

FIG. 2 is a flowchart of a focus control method in Embodiment 1 of the present invention.

FIG. 3 is a signal waveform chart of the focus control method in Embodiment 1.

FIG. 4 is a signal waveform chart of a focus control method in Embodiment 1.

FIG. 5 is a signal waveform chart of a focus control method in Embodiment 1.

FIG. 6 is a flowchart of a focus control method in Embodiment 2 of the present invention.

FIG. 7 is a signal waveform chart of the focus control method in Embodiment 2.

FIG. 8 is a signal waveform chart of a focus control method in Embodiment 2.

FIG. 9 is a signal waveform chart of a focus control method in Embodiment 2.

FIG. 10 is a flowchart of a focus control method in Embodiment 3 of the present invention.

FIG. 11 is a signal waveform chart of the focus control method in Embodiment 3.

FIG. 12 is a signal waveform chart of a focus control method in Embodiment 4 of the present invention.

FIG. 13 is a signal waveform chart of a focus control method in Embodiment 4.

FIG. 14 is a flowchart of a focus control method in Embodiment 5 of the present invention.

FIG. 15 is a signal waveform chart of the focus control method in Embodiment 5.

FIG. 16 is a flowchart of a focus control method in Embodiment 6 of the present invention.

FIG. 17 is a signal waveform chart of a focus control method in Embodiment 7 of the present invention.

FIG. 18 is a signal waveform chart of a focus control method in Embodiment 7.

FIG. 19 is a signal waveform chart of a focus control method in Embodiment 8 of the present invention.

FIG. 20 is a flowchart of a focus control method in Embodiment 9 of the present invention.

FIG. 21 is a signal waveform chart of the focus control method in Embodiment 9.

FIG. 22 is a signal waveform chart of a focus control method in Embodiment 9.

FIG. 23 is a flowchart of a focus control method in Embodiment 10 of the present invention.

FIG. 24 is a view demonstrating the operation principle of the focus control method in Embodiment 10.

FIG. 25 is a signal waveform chart of the focus control method in Embodiment 10.

FIG. 26 is a flowchart of a focus control method in Embodiment 10.

FIG. 27 is a view demonstrating the operation principle of the focus control method in Embodiment 10.

FIG. 28 is a flowchart of a focus control method in Embodiment 11 of the present invention.

FIG. 29 is a view demonstrating the operation principle of the focus control method in Embodiment 11.

FIG. 30 is a flowchart of a focus control method in Embodiment 12 of the present invention.

FIG. 31 is a flowchart of a focus control method in Embodiment 12.

FIG. 32 is a flowchart of a focus control method in Embodiment 13 of the present invention.

FIG. 33 is a signal waveform chart of the focus control method in Embodiment 13.

FIG. 34 is a signal waveform chart of a focus control method in Embodiment 13.

FIG. 35 is a signal waveform chart of a conventional focus control method for an optical disk having an excessively large vertical deviation.

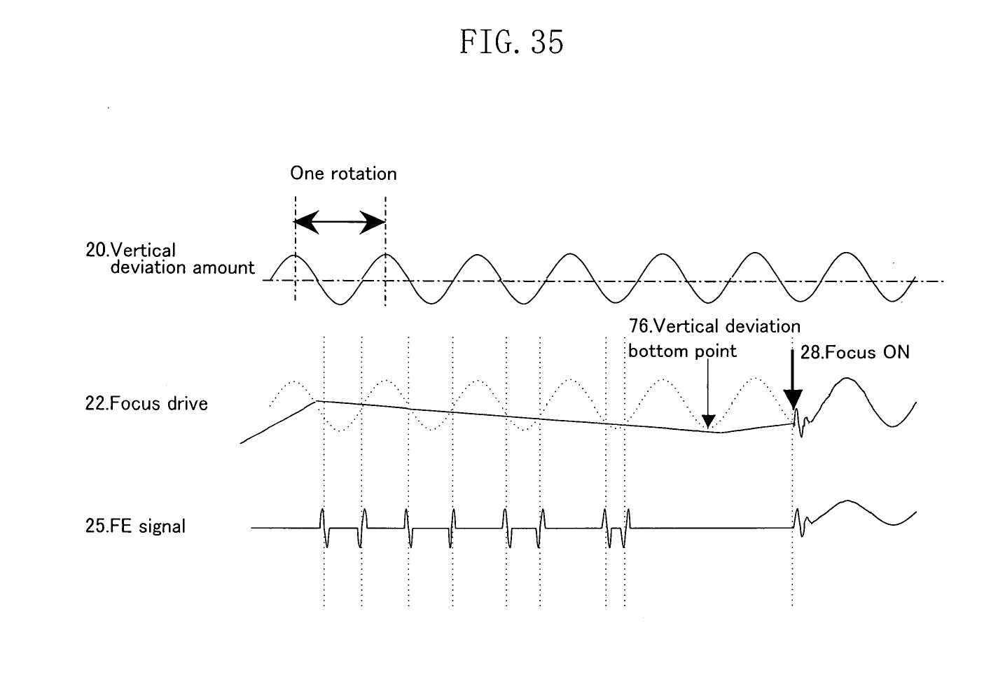

FIG. 36 is a signal waveform chart of a conventional method for performing focus jumping for an optical disk having an excessively large vertical deviation.

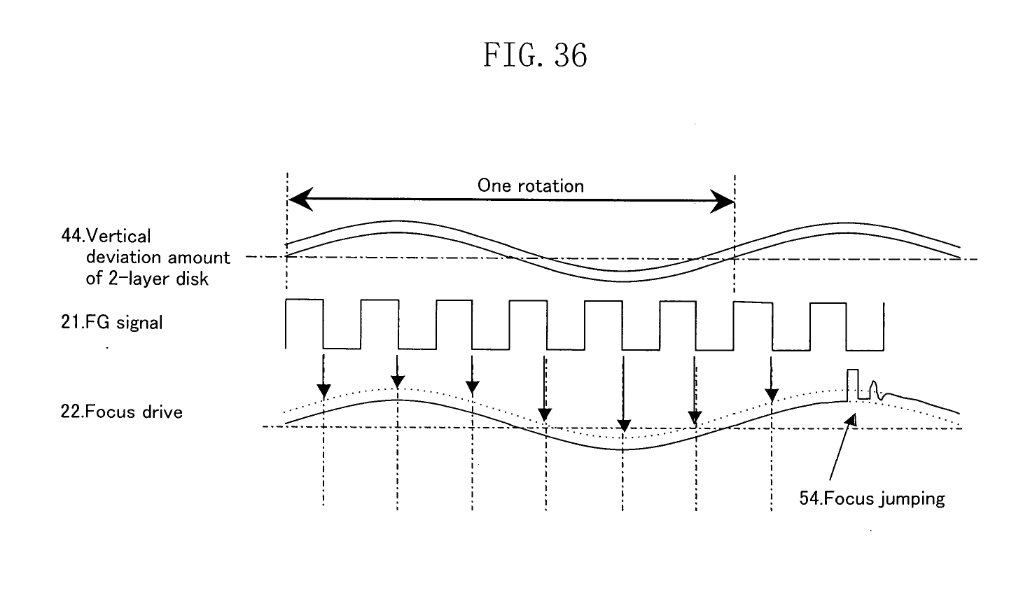

FIG. 37 is a signal waveform chart of a conventional method for determining the number of layers of a multilayer optical disk.

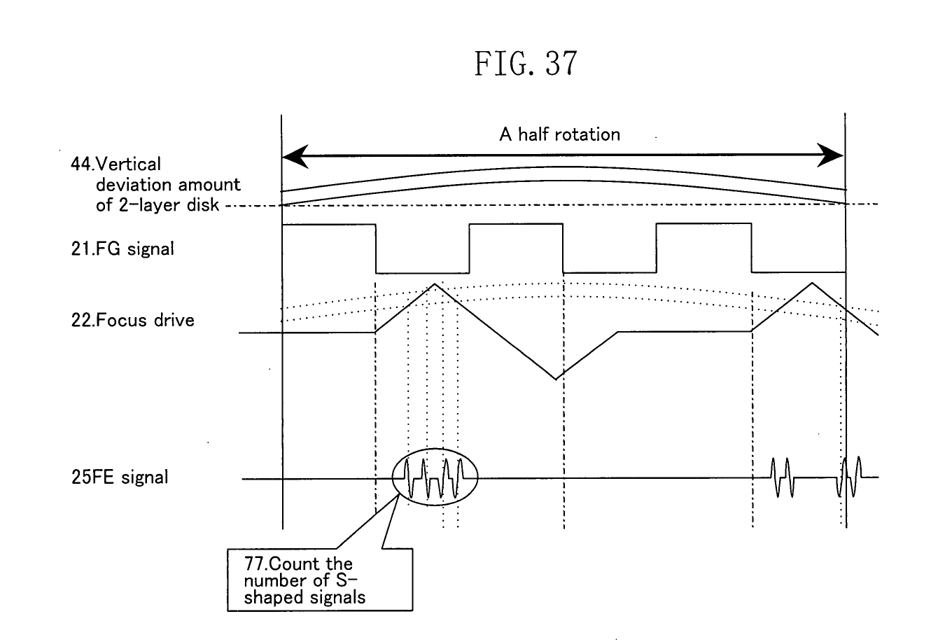

### DESCRIPTION OF THE PREFERRED EMBODIMENTS

Hereinafter, preferred embodiments of the present invention will be described with reference to the accompanying drawings.

### Embodiment 1

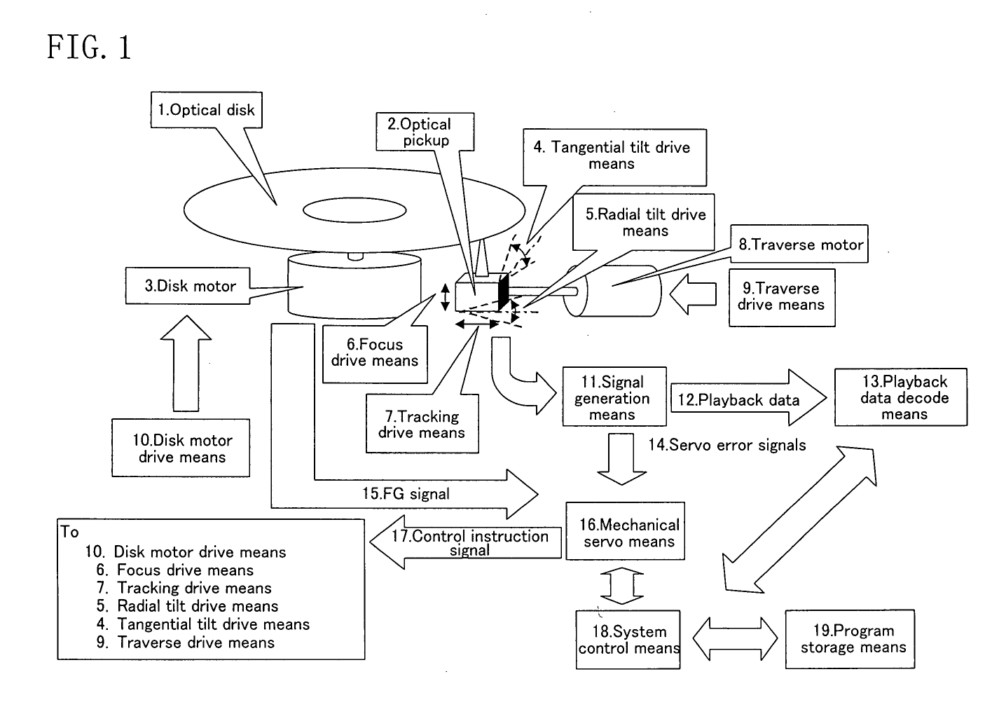

Embodiment 1 of the present invention will be described with reference to FIGS. 1 to 4.

FIG. 1 shows a schematic construction of an optical disk device. The optical disk device used in the embodiments of the present invention is the same in construction as the conventional optical disk device described above, and thus detailed description thereof is omitted here.

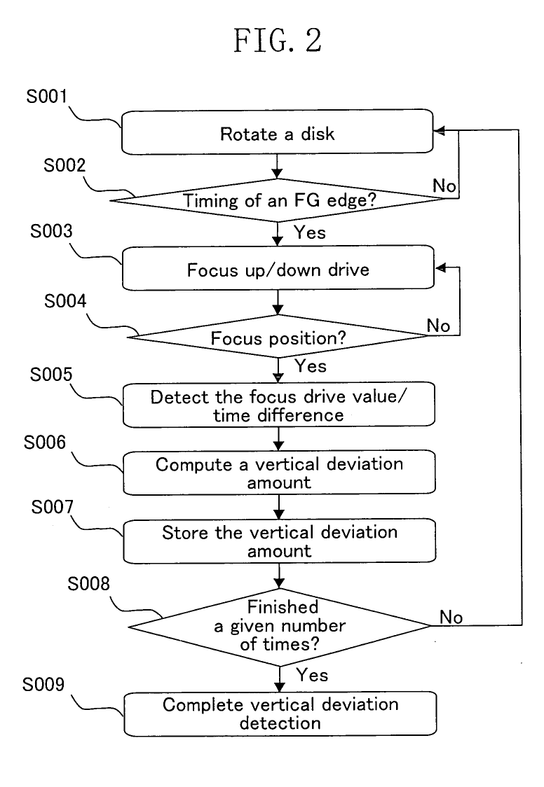

FIG. 2 shows a flowchart of a focus control method in Embodiment 1 of the present invention. An optical disk is rotated (S001), and whether or not it is timing of an edge of the FG signal is determined (S002). If it is determined to be timing of an edge of the FG signal, focus up/down operation is performed (S003), to detect a focus position at which the focal point of the light beam is located on a recording surface of the optical disk (S004). The focus drive value at the timing of detection of the focus position and the time difference between the timing of the edge of the FG signal and the timing of detection of the focus position are determined (S005), to thereby compute the vertical deviation amount (S006), and the computed vertical deviation amount is stored (S007). Whether or not the detection of vertical deviation has been made a given number of times is determined (S008). If so, the vertical deviation detection is completed (S009).

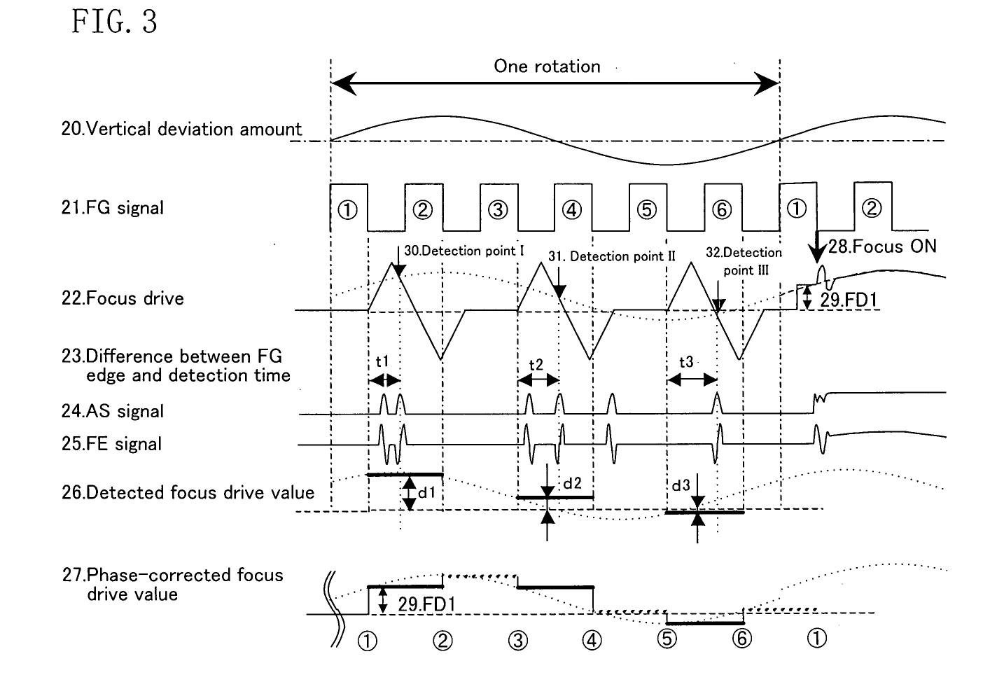

FIG. 3 shows signal waveforms related to a focus control method in Embodiment 1. If an optical disk has a vertical deviation, the vertical deviation mostly takes the shape of a sine wave of which one period corresponds to one rotation of the optical disk, as a sine-wave shaped vertical deviation amount 20. With rotation of the optical disk, focus up/down drive, in which the optical pickup is moved in a direction vertical to the optical disk closer to or farther from the optical disk and then moved in the opposite direction, is made three or more times in one rotation, as focus drive 22 in FIG. 3, at timing of at least a rising edge or a falling edge of an FG signal 21 having a given number of pulses per rotation. It is determined that the focal point of the light beam is located on a recording surface of the optical disk at least from the timing at which the value of an AS signal 24 as the summation of all signals from the optical pickup is at its peak or from the timing at which an S-shaped signal of an FE signal 25 generated when the focal point of the light beam passes through a recording surface of the optical disk is at its median between the highest and lowest values. Focus drive values (d1, d2 and d3) at the detection timing points I (30), II (31) and III (32), and the time differences (t1, t2 and t3) between the edges of the FG signal 21 at which the focus up/down drive has been started and the timing at which the focal point of the optical beam is located on a recording surface of the optical disk are detected. The change in vertical deviation amount with rotation of the optical disk is approximated to a sine wave using the respective detection points, and the displacement state resulting from the vertical deviation in one rotation is computed by expression 1 below.
FD(N)=A×Sin(π×N/3+B+t)+C (1)
(assume that the FG signal has six pulses per rotation)
   where FD(N) denotes the vertical deviation amount (d1, d2, d3) at given FG signal timing, A denotes the amplitude of the vertical deviation amount, B denotes a radial deviation of the change in vertical deviation with respect to an edge of the FG signal as the reference, t denotes the difference between an edge of the FG signal and the detection time (t1, t2, t3), C denotes the offset amount obtained by averaging the vertical deviation amount in one rotation of the optical disk, and N denotes a given pulse number (integer) among the numbered pulses of the FG signal.

Three simultaneous equations are introduced from the expression 1 using the values detected at the respective detection points I, II and III, to compute the three constants A, B and C in the expression 1. A focus drive value FD1 (29) at timing of a given edge of the FG signal coming after the detection of the vertical deviation amount of the optical disk from focus drive amounts computed for the respective FG signal pulses is applied in advance before the timing of the given edge of the FG signal as the focus drive value, so that focus ON 28 is attained at the timing of the given edge of the FG signal. That is, after the detection of the focus drive amounts in association with the respective FG signal pulses (encircled numbers 1, 2, 3, 4, 5 and 6 in FIG. 3), the focus drive amount for an FG signal pulse may be applied at timing of an edge of the FG signal pulse as the focus drive value whenever necessary, to thereby enables execution of the focus ON at timing of any edge of the FG signal. Although the focus up/down drive is repeated three times in one rotation in FIG. 3, the same effect will naturally be obtained when the number of times of the drive is greater than this.

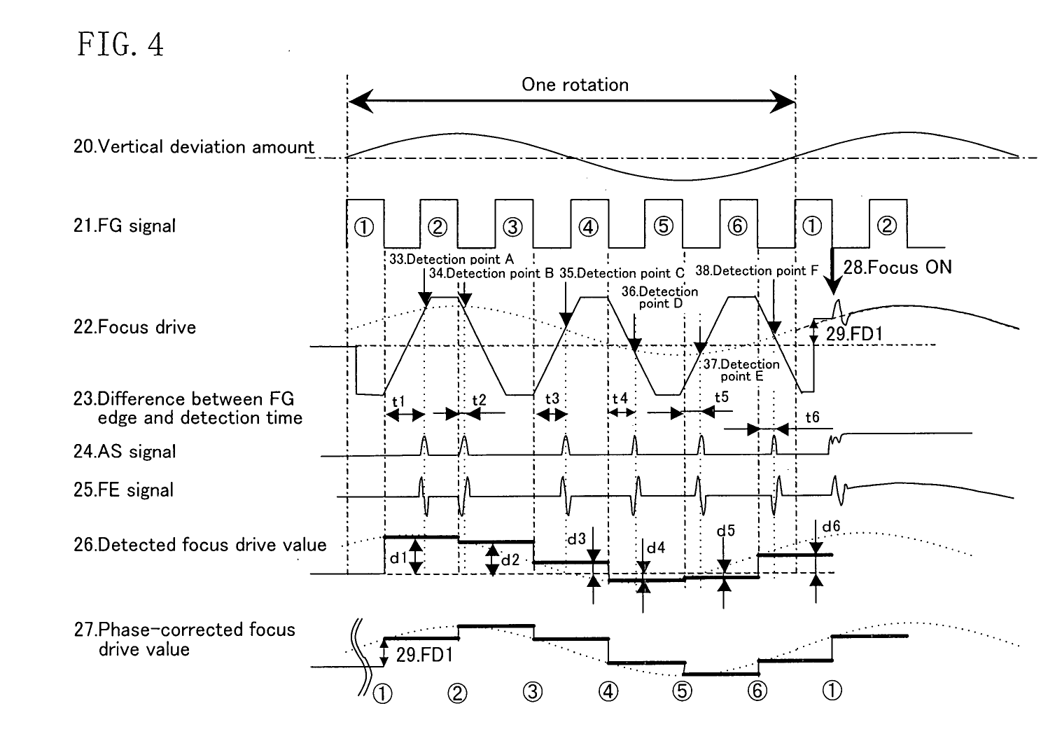

FIG. 4 shows signal waveforms related to a focus control method in Embodiment 1 permitting higher detection precision. This method is different from the focus control method in FIG. 3 in that focus drive is made to be closer to or farther from the optical disk at timing of at least either the rising edge or the falling edge of a given FG signal pulse and is then made in the opposite direction at timing of an edge of a given FG signal pulse after the above pulse. The other waveforms are the same as those in FIG. 3 and thus the description thereof is omitted here. This method provides a larger amount of data on the focus drive values per rotation detected at the timing at which the focal point of the optical beam is located on a recording surface of the optical disk, and thus the detection precision is improved.

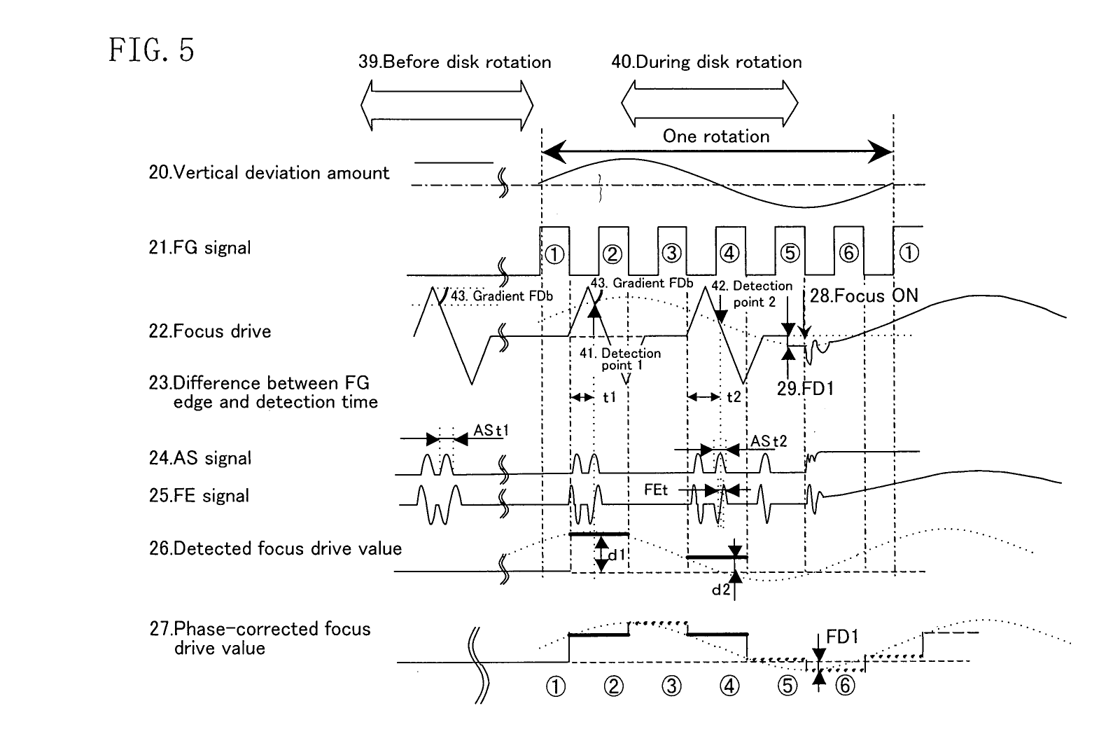

FIG. 5 shows signal waveforms related to a focus control method in Embodiment 1 permitting smaller power consumption. The focus drive 22 is made as follows. Before rotation of the optical disk (39), focus up/down drive is made with a given gradient FDb (43) of the change in focus drive value with time so that the focal point of the optical beam passes through a recording surface of the optical disk, to detect the time (ASt1) for which the AS signal exceeds a given value. During rotation of the optical disk (40), the focus up/down drive is made with the given gradient FDb (43) of the change in focus drive 22 with time at timing of two given edges of the FG signal. From the focus drive values (d1 and d2) at the timing at which the focal point of the optical beam is located on a recording surface of the optical disk and the differences 23 (t1 and t2) between the timing of the given edges of the FG signal and the timing of the detection, and also from the ratio of the time ASt2 for which the AS signal value exceeds the set value at the two given edges of the FG signal to the time ASt1, the relative rate of the change in the vertical deviation amount of the optical disk with rotation of the optical disk to the given gradient FDb (43) of the focus drive value is determined. Using at least three out of four pieces of information, that is, the focus drive values and the focus drive relative rates at the two detection points, the vertical deviation amount of the optical disk is determined by the following expressions. This method aims to reduce the power consumption because the number of times of the focus up/down drive can be reduced.
Focus drive value: FD(N)=A×Sin(π×N/3+B+t)+C (1)

Focus drive relative rate:
FD(N)/dN={A×Sin(π×N/3+B+t)+C}/dN (2)

Although the FG signal was described as having six pulses for each rotation of the optical disk in FIGS. 3 to 5 and the expressions 1 and 2, the same effect as that described above will naturally be obtained with any number of pulses other than six.

### Embodiment 2

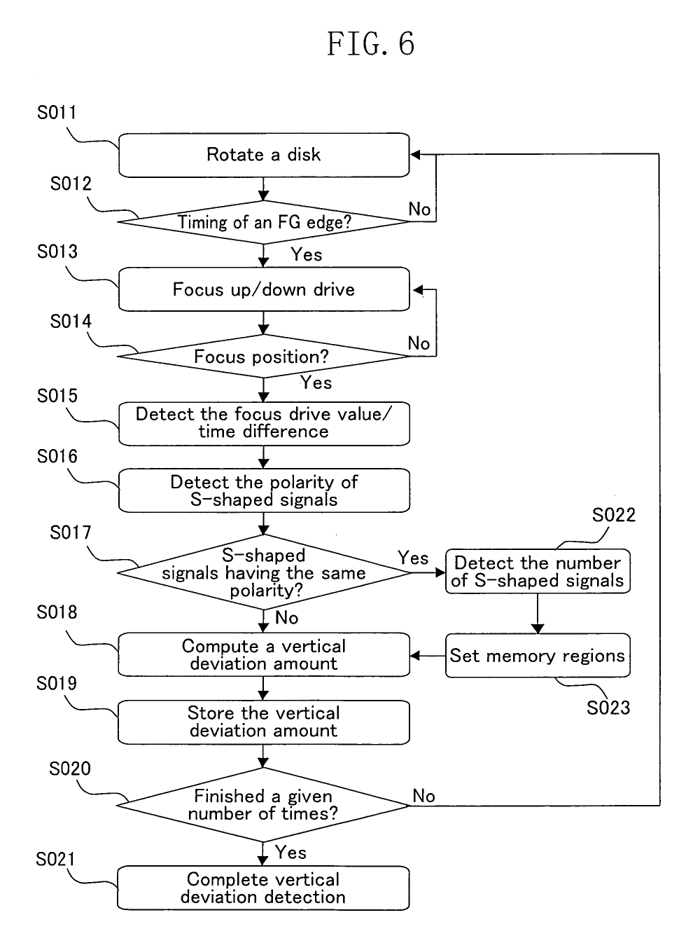

Focus control methods in Embodiment 2 of the present invention will be described with reference to FIGS. 6 to 9.

FIG. 6 shows a flowchart of a focus control method in Embodiment 2. An optical disk is rotated (S011), and whether or not it is timing of an edge of the FG signal is determined (S012). If it is determined to be timing of an edge of the FG signal, focus up/down operation is performed (S013), to detect a focus position at which the focal point of the light beam is located on a recording surface of the optical disk (S014). The focus drive value at the timing of detection of the focus position and the time difference between the timing of the edge of the FG signal and the timing of the detection of the focus position are determined (S015). The polarity of an S-shaped signal of the FE signal generated when the focal point of the light beam passes through a recording surface of the optical disk is detected (S016). When a plurality of S-shaped signals are generated, whether or not the plurality of S-shaped signals have the same polarity is determined (S017). If they have the same polarity, the number of S-shaped signals of the FE signal is detected (S022). Storage regions are set according to the detected number of signals (S023), and then the vertical deviation amount is computed (S018). The computed vertical deviation amount is stored (S019), and whether or not the detection of vertical deviation has been made a given number of times is determined (S020). If so, the vertical deviation detection is completed (S021).

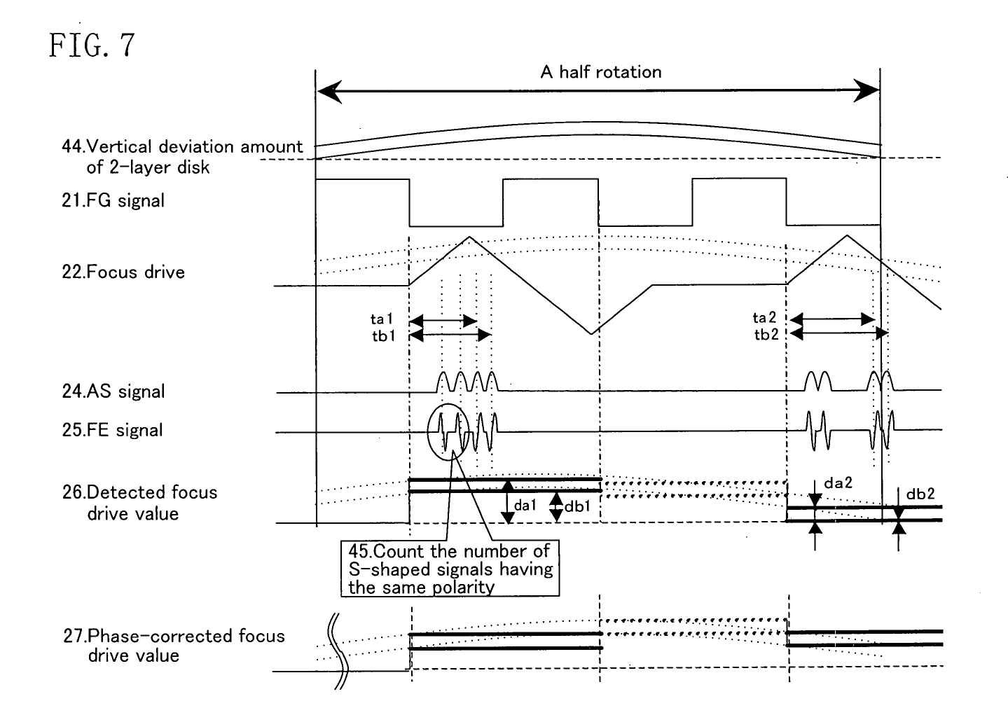

FIG. 7 shows signal waveforms related to a focus control method in Embodiment 2 in playback of a dual-layer optical disk. A vertical deviation amount 44 of the dual-layer optical disk changes in the shape of a sine wave with rotation of the optical disk. The focus up/down drive is started at timing of at least the rising edge or the falling edge of a given pulse of the FG signal 21 representing the rotational angle of the optical disk, in which the optical pickup is moved in a direction vertical to the optical disk closer to or farther from the optical disk and then moved in the opposite direction. The timing at which the focal point of the light beam is located on a recording surface of the optical disk is detected from the timing at which the AS signal, as the summation of all signals obtained from the outputs of light-receiving elements provided on the optical pickup, is at its peak, at which the focal point of the optical beam passes through any of the two recording surfaces of the optical disk, or from the timing at which an S-shaped signal of the FE signal generated when the focal point of the light beam passes through a recording surface of the optical disk is at its median between the highest and lowest values. The focus drive value (da1, db1) at the detected timing is detected, and simultaneously, the time difference (ta1, tb1) between the timing of the given edge of the FG signal and the timing of the detection of the focus drive value at which the focal point of the optical beam is located on the recording surface of the optical disk is also detected. Whether the polarity of the S-shaped signal of the FE signal is such that the S-shaped signal first shifts to a higher level from the reference position and then shifts to a lower level during the focus up/down operation, or it first shifts to a lower level and then shifts to a higher level is determined. The number of S-shaped signals of the same polarity is counted from the start of the focus up/down operation, to thereby determine the number of recording surfaces of the optical disk. According to the determination result, the vertical deviation amount for each layer detected by the method described above is stored in the storage means, and based on the stored vertical deviation amount for each layer, focus control is performed.

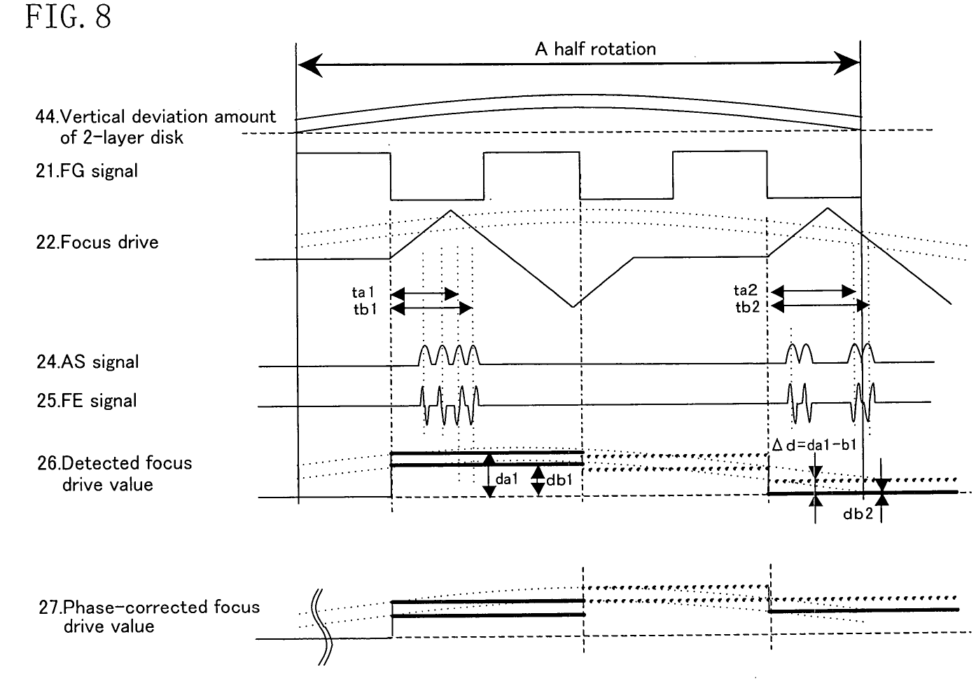

FIG. 8 shows signal waveforms related to a focus control method in Embodiment 2 that can reduce the capacity of the storage means for storing the vertical deviation amount of the optical disk in association with edges of the FG signal. This method is different from the focus control method in FIG. 7 in that the focus drive values (da1 and db1) corresponding to the vertical deviation amounts for different layers of an optical disk are detected in the first focus up/down drive, and the focus drive value difference Δd corresponding to the distance between the plurality of layers of the optical disk is computed from the difference between the detected focus drive values. In the second and subsequent focus up/down drives, only the focus drive value for the recording surface of one layer out of the plurality of layers of the optical disk is detected, and the vertical deviation amount for any of the other layers can be obtained by adding or subtracting the focus drive value difference Δd for the relevant layers. This eliminates the necessity of preparing storage regions for storing the vertical deviation table by the number of layers of the optical disk, and thus provides the effect of reducing the capacity of the storage means.

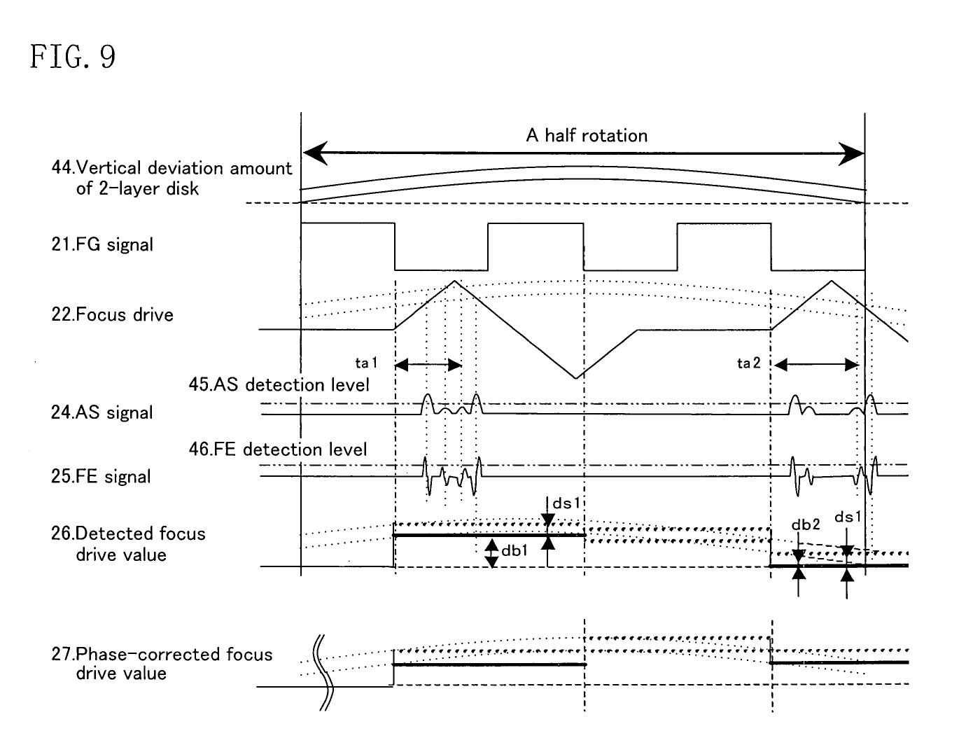

FIG. 9 shows signal waveforms related to a focus control method in Embodiment 2 that can avoid a flaw and the like from affecting the detection of a vertical deviation of a multilayer optical disk. This method is different from the focus control method in FIG. 7 in that this additionally provides a method for determining that the value of the AS signal has exceeded a given threshold 45 and a method for determining that the FE signal has exceeded a given threshold 46. In detection of the timing at which the focal point of the light beam is located on the recording surface by performing the focus drive 22, the detection precision of the vertical deviation amount may be degraded if reflected light from the optical disk becomes weak due to a flaw and the like on the optical disk, for example, and as a result the value of the AS signal or the S-shaped signal of the FE signal becomes smaller than a given set value. To prevent such occurrence, in at least either the event that the value of the AS signal has failed to exceed a given threshold or the event that the value of the FE signal has failed to exceed a given threshold, the detection of the positional relationship between the focal point of the light beam and the recording surface of the optical disk is not performed, but the vertical deviation amounts for the plurality of layers are determined by executing addition/subtraction of a focus drive value detected at timing at which the AS signal or the FE signal has exceeded the relevant threshold and a given set value obtained by adding the distance between the layers of the optical disk to the detected focus drive value.

In FIGS. 7 to 9, the description was made assuming that playback was made for a dual-layer optical disk. The same effect as that described above will naturally be obtained with optical disks having more than two layers. Also, in FIGS. 7 to 9, the description was made assuming that the FG signal had six pulses for each rotation of the optical disk. The same effect as that described above will naturally be obtained with any number of pulses other than six.

### Embodiment 3

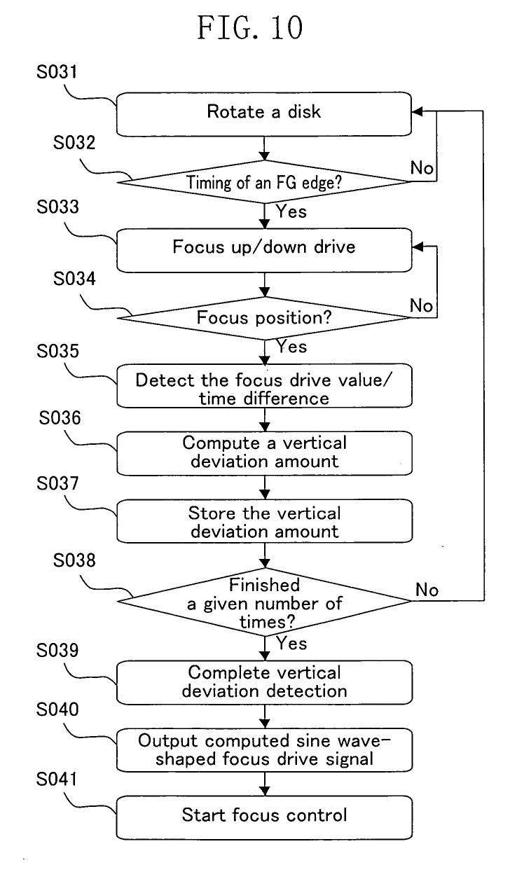

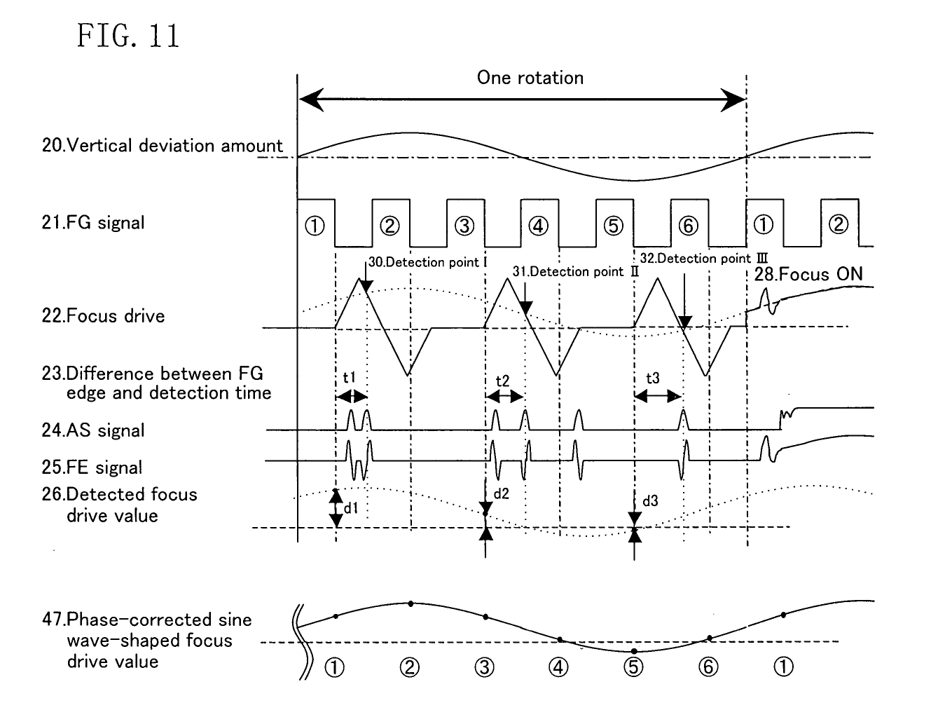

Embodiment 3 of the present invention will be described with reference to FIGS. 10 and 11. FIG. 10 shows a flowchart of a focus control method in Embodiment 3. An optical disk is rotated (S031), and whether or not it is timing of an edge of the FG signal is determined (S032). If it is determined to be timing of an edge of the FG signal, focus up/down operation is performed (S033), to detect a focus position at which the focal point of the light beam is located on the recording surface of the optical disk (S034). The focus drive value at the timing of detection of the focus position and the time difference between the timing of the edge of the FG signal and the timing of the detection of the focus position are determined (S035), to compute the vertical deviation amount (S036), and the computed vertical deviation amount is stored (S037). Whether or not the detection of vertical deviation has been made a given number of times is determined (S038). If so, the vertical deviation detection is completed (S039). A focus drive signal in the shape of a sine wave corresponding to the computed vertical deviation amount is output (S040), and focus control is started at given timing (S041).

FIG. 11 shows signal waveforms related to a method in which focus ON can be made at any time irrespective of the timing of an edge of the FG signal after the detection of the vertical deviation amount of the optical disk. This method is different from Embodiment 1 in that after the detection of the vertical deviation amount in one rotation of the optical disk, a focus drive value in the shape of a sine wave approximated to the vertical deviation amount of the optical disk over the adjacent FG signal pulses is applied. By applying the focus drive value in the shape of a sine wave, the focal point of the light beam is always located near a recording surface of the optical disk, and thus focus control can be started at any timing, independent of the timing of an edge of the FG signal as in Embodiment 1.

### Embodiment 4

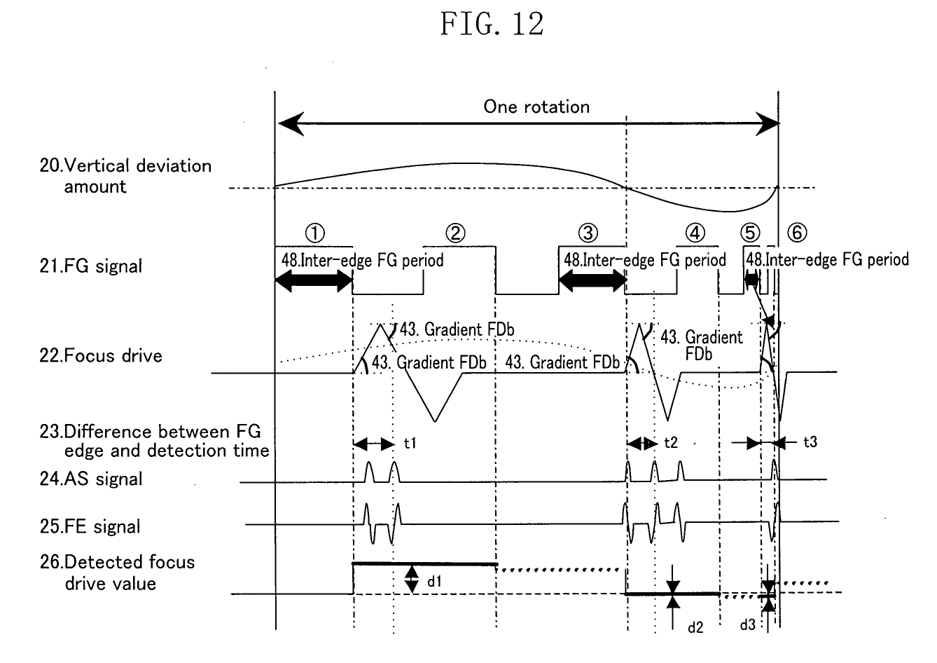

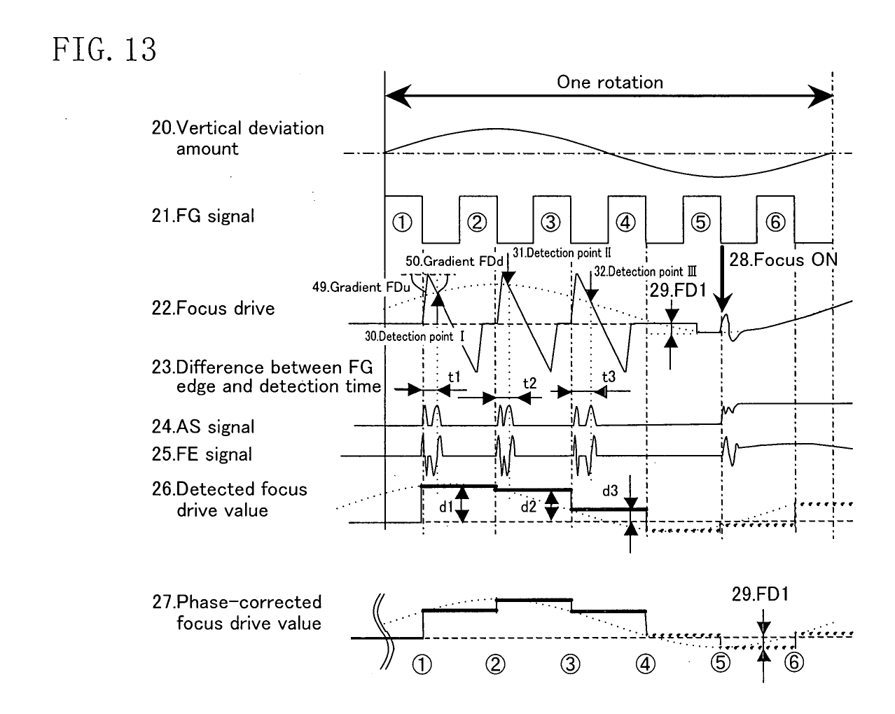

Focus control methods in Embodiment 4 of the present invention will be described with reference to FIGS. 12 and 13. FIG. 12 shows signal waveforms related to a method in which the gradient of the change in focus up/down drive value with time is changed with the inter-edge period of the FG signal. The gradient FDb (43) of the change in focus drive value 22 with time is changed with the length of the inter-edge period 48 of the FG signal 21. The gradient FDb (43) of the change in focus drive value 22 is set milder as the inter-pulse period 48 of the FG signal is longer, and steeper as the inter-pulse period 48 is shorter. The focus up/down operation is made at timing of a given edge of the FG signal, to detect the focus drive value (d1, d2, d3) at the time at which the focal point of the light beam is located on the recording surface of the optical disk, and simultaneously detect the time difference (t1, t1, t3) between the timing of the given edge of the FG signal and the timing at which the focal point of the optical beam is located on the recording surface of the optical disk. The vertical deviation amount in one rotation of the optical disk is computed using the expression 1 given in Embodiment 1, and focus control is performed based on the computed vertical deviation amount of the optical disk. According to the focus control method in Embodiment 4, the positional relationship between the focal point of the light beam and the recording surface of the optical disk can be detected at a desired position irrespective of the number of revolutions of the optical disk. For example, the vertical deviation amount of the optical disk can be detected even during initial acceleration of the rotation of the optical disk after startup of the device in which the rotational angular velocity is not stable, and this can shorten the startup time.

FIG. 13 shows signal waveforms related to a method that can shorten the time for detection of the vertical deviation amount of the optical disk. Referring to FIG. 13, the gradient FDu (49) of the change in focus drive value with time in the movement of the optical pickup in a direction vertical to the optical disk to be closer to the optical disk and the gradient FDd (50) of the change in the movement of the optical pickup to be farther from the optical disk are individually set at given values. For example, in the case that the detection of the focus drive value 22 is made when the focal point of the light beam is located on the recording surface of the optical disk during the movement of the light beam in a direction away from the optical disk, the gradient FDd (50) of the focus drive value 22 is made mild. The gradient FDu (49) is made steep if no detection is made during the movement of the light beam in a direction closer to the optical disk. The focus up/down operation is made three or more times in one rotation, to detect the focus drive value (d1, d2, d3) at each detection point, and simultaneously detect the time difference (t1, t1, t3) between the timing of each given edge of the FG signal and the timing of the detection of the focus drive value. The vertical deviation amount in one rotation of the optical disk is computed using the expression 1 given in Embodiment 1, and focus control is performed based on the computed vertical deviation amount. Thus, since wasted time involving no detection of the vertical deviation amount of the optical disk is minimized, the detection time can be shortened.

### Embodiment 5

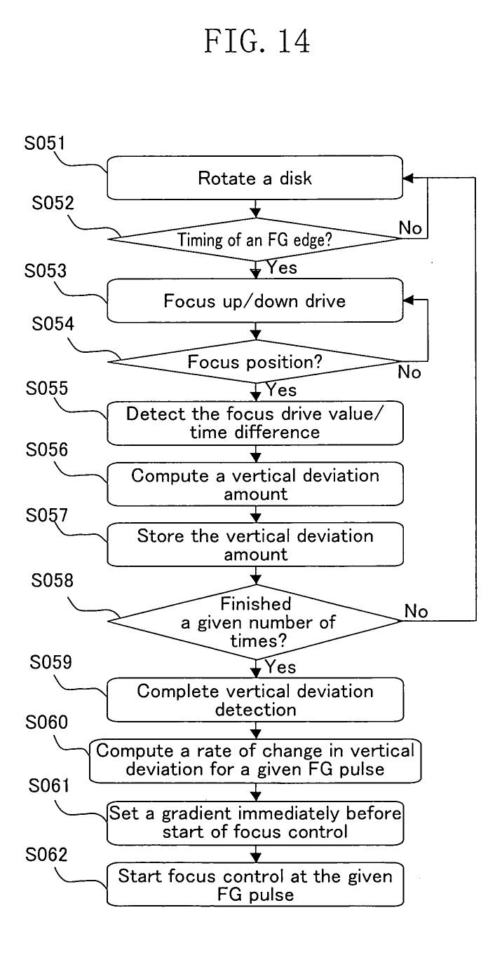

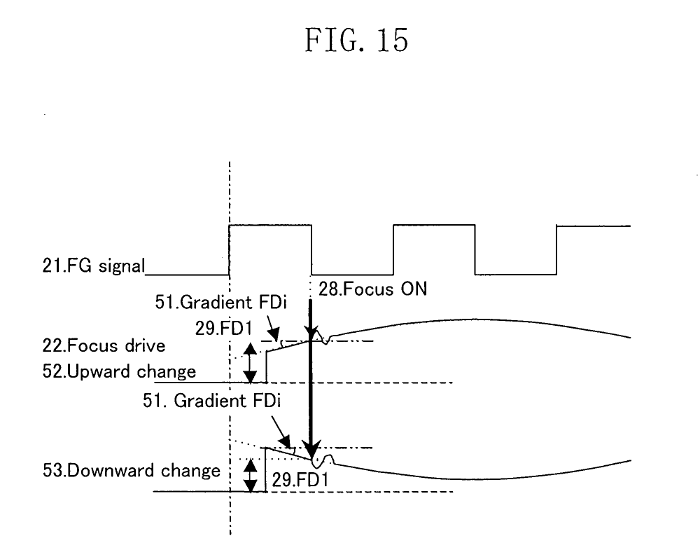

A focus control method in Embodiment 5 of the present invention will be described with reference to FIGS. 14 and 15.

FIG. 14 shows a flowchart in Embodiment 5. An optical disk is rotated (S051), and whether or not it is timing of an edge of the FG signal is determined (S052). If it is determined to be timing of an edge of the FG signal, focus up/down operation is performed (S053), to detect a focus position at which the focal point of the light beam is located on the recording surface of the optical disk (S054). The focus drive value at the timing of detection of the focus position and the time difference between the timing of the edge of the FG signal and the timing of the detection of the focus position are determined (S055), to compute the vertical deviation amount (S056), and the computed vertical deviation amount is stored (S057). Whether or not the detection of vertical deviation has been made a given number of times is determined (S058). If so, the vertical deviation detection is completed (S059). The amount of change in vertical deviation amount with time for a given FG signal pulse is computed (S060), the gradient at a time immediately before start of focus control is set from the computed value (S061), and the focus control is started at the given edge of the FG signal (S062).

FIG. 15 shows signal waveforms related to a focus control method performed immediately before start of focus control after the detection of the vertical deviation amount of the optical disk. In the start of focus control at timing of a given edge of the FG signal after the detection of the vertical deviation amount of the optical disk, the change in vertical deviation amount with time for the given edge of the FG signal is computed. The gradient DFi (51) of the change in focus drive value with time is set so that the focus drive value is mildly approximated to the computed change in vertical deviation amount with time and finally reaches the focus drive value FD1 (29) for the given edge of the FG signal, computed from the detection result of the vertical deviation amount, at the timing of the given edge of the FG signal. The focus control is then started. The gradient FDi (51) of the change in focus drive value 22 with time is set at a positive value when the vertical deviation amount of the optical disk at the given edge of the FG signal changes upwardly (52), and is set at a negative value when it changes downwardly (53). By this setting, the focus position of the optical pickup can be mildly brought closer to a recording surface of the optical disk, and thus the focus control can be started more stably.

### Embodiment 6

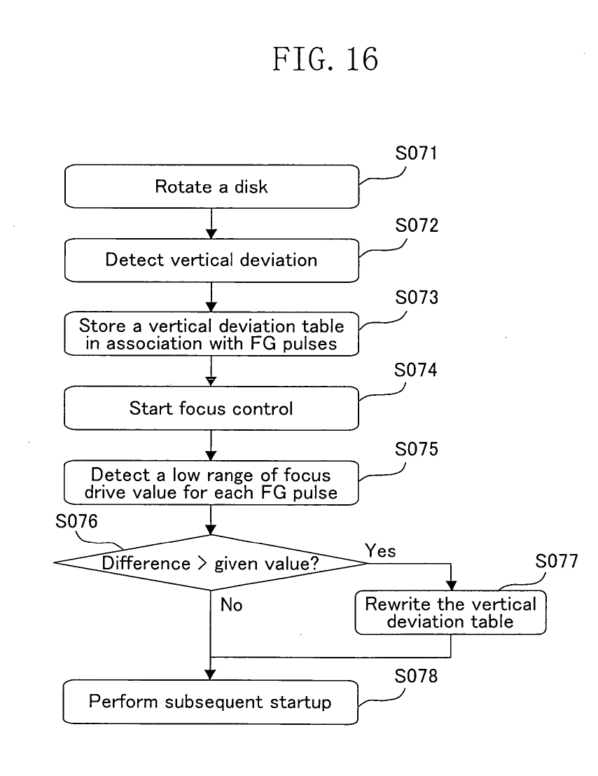

A focus control method in Embodiment 6 of the present invention will be described with reference to FIG. 16. FIG. 16 shows a flowchart of a method for correcting the vertical deviation amount of the optical disk detected before start of focus control. The rotation of an optical disk is started (S071), and the vertical deviation amount is detected in association with FG signal pulses by any of the methods described in Embodiments 1 to 5 (S072). The detected vertical deviation amount is stored in association with each FG signal pulse in the form of a vertical deviation table (S073), and focus control is started (S074). During the execution of the focus control, a low-range component of the focus drive value is detected at timing of each pulse of the FG signal (S075). The difference between the detected low-range component and the value stored in the vertical deviation table in association with the corresponding pulse of the FG signal is computed, and the computed difference is compared with a given set value (S076). If the difference is greater than the set value, the relevant value in the vertical deviation table is replaced with the value detected during the focus control (S077). If the difference is smaller than the set value, the startup operation is continued (S078). In the event of existence of a defect on the optical disk, the vertical deviation table prepared from the vertical deviation amount detected before execution of the focus control may have an error due to the defect. Even in such an event, a focus drive value detected during the focus control can be used to provide a high-precision vertical deviation table.

### Embodiment 7

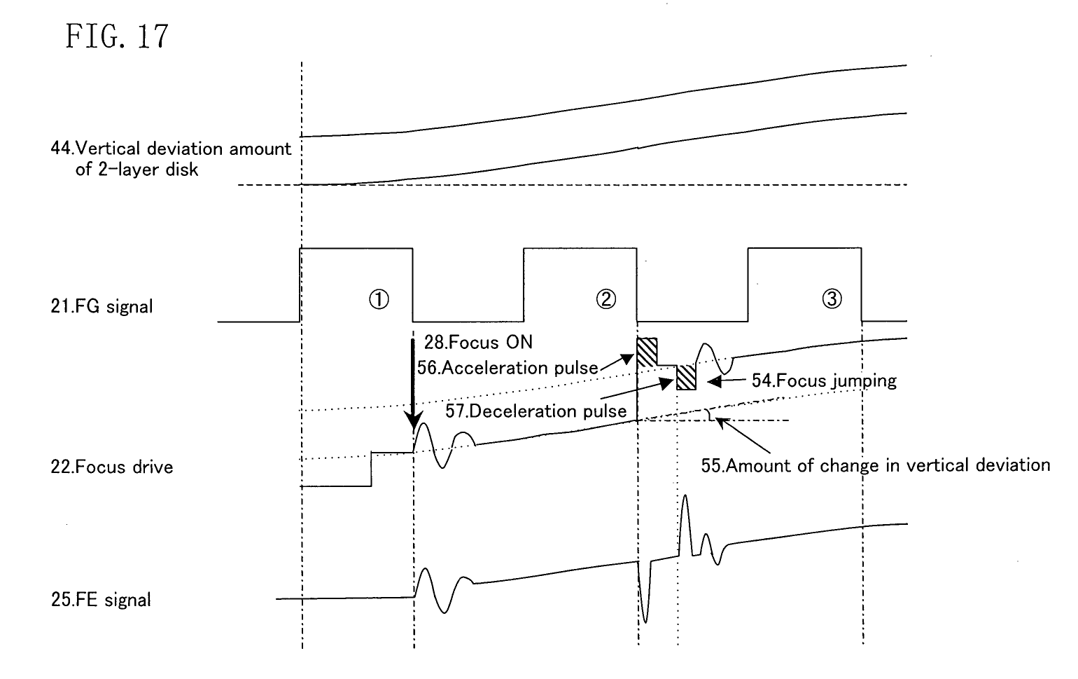

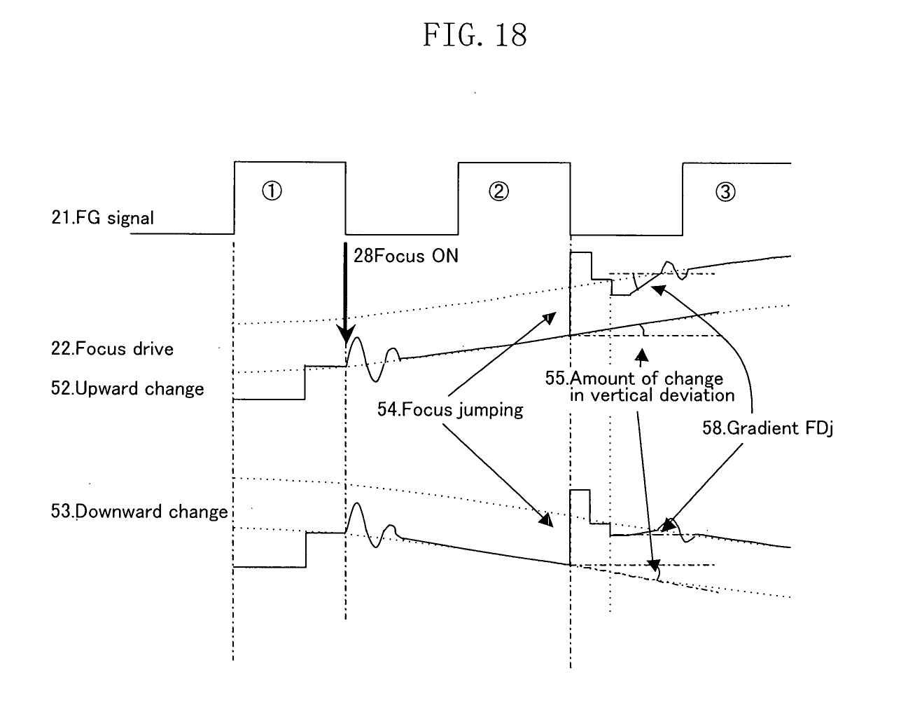

Focus control methods in Embodiment 7 of the present invention will be described with reference to FIGS. 17 and 18.

FIG. 17 shows signal waveforms related to a method for changing focus jumping with the vertical deviation amount. The focus jumping refers to shifting the focal point of the light beam from a given layer of a multilayer optical disk to another layer thereof. The vertical deviation amount is detected before start of focus control for a given layer, and then the focus control is started (focus ON 28) for the given layer. Focus jumping 54 is executed by individually setting the acceleration peak value and acceleration time of an acceleration pulse 56 for moving the optical pickup toward the destination layer at timing of a given FG signal pulse, and also individually setting the deceleration peak value and deceleration time of a deceleration pulse 57 output near the timing at which passing of the focal point of the light beam through the destination layer has been detected. In execution of the focus jumping 54, the amount of change in vertical deviation at timing of a given FG signal pulse is computed, and at least either the acceleration peak value or the acceleration time or at least either the deceleration peak value or the deceleration time is changed according to the computed change amount. By changing the acceleration peak value and the acceleration time or the deceleration peak value and the deceleration time with the amount of change in the vertical deviation amount of the optical disk, the focus jumping can be executed stably.

FIG. 18 shows signal waveforms related to a method for executing focus jumping more stably. In the focus jumping 54 from a given layer of a multilayer optical disk to another layer thereof, when the focus control is re-introduced for the destination layer at timing of a given FG signal pulse, the amount of change in vertical deviation with time (55) at timing of the given FG signal pulse is computed. The gradient FDj (58) of the change in focus drive value 22 with time is changed so that the focal point of the light beam is mildly approximated to the computed amount of change with time (55), to enable start of the focus control at the timing of the given FG signal pulse. Since the difference of the gradient of the change in focus drive value 22 with time from the change in the vertical deviation amount of the optical disk with time (55) is small, the focus control can be started stably.

### Embodiment 8

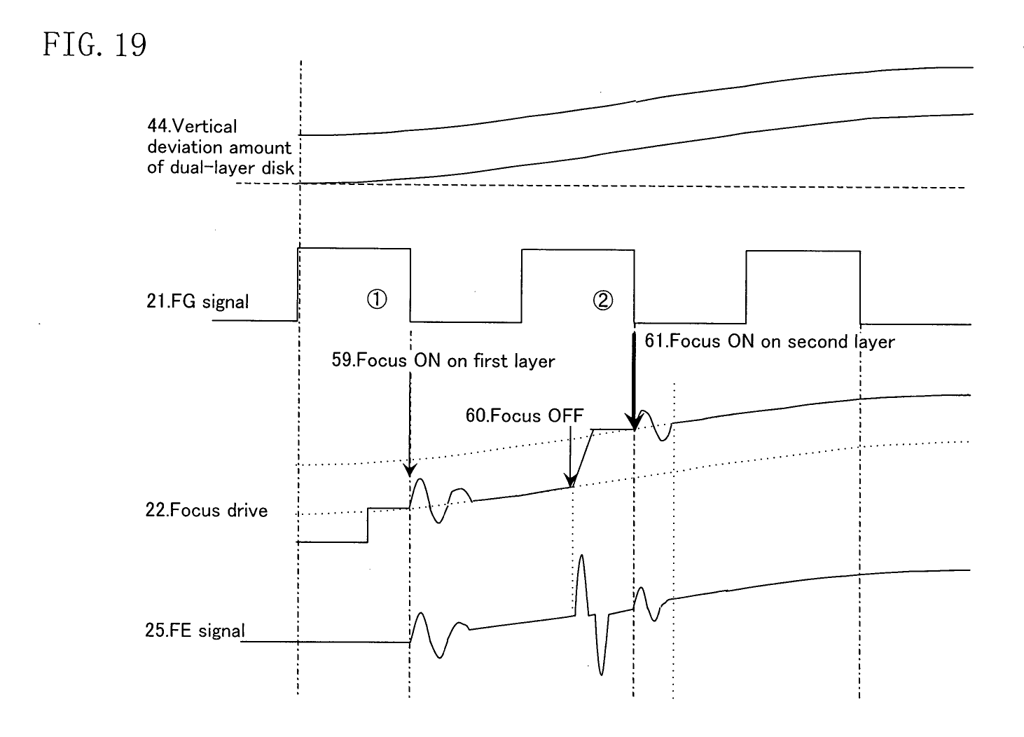

A focus control method in Embodiment 8 of the present invention will be described with reference to FIG. 19. FIG. 19 shows signal waveforms related to a method in which no FE signal is used in focus jumping in playback of a multilayer optical disk. In the focus jumping for shifting the focal point of the light beam from a given layer of the multilayer optical disk to another layer thereof, the position of the destination recording surface at timing of a given edge of the FG signal is computed. The focus drive value 22 is set in advance before the given edge of the FG signal so that the focal point of the light beam is located on the computed position of the recording surface, and focus control (59) is started at the timing of the given edge of the FG signal. In this way, inter-layer shifting of the focal point of the light beam can be attained by a simple method without use of the FE signal in the focus jumping.

### Embodiment 9

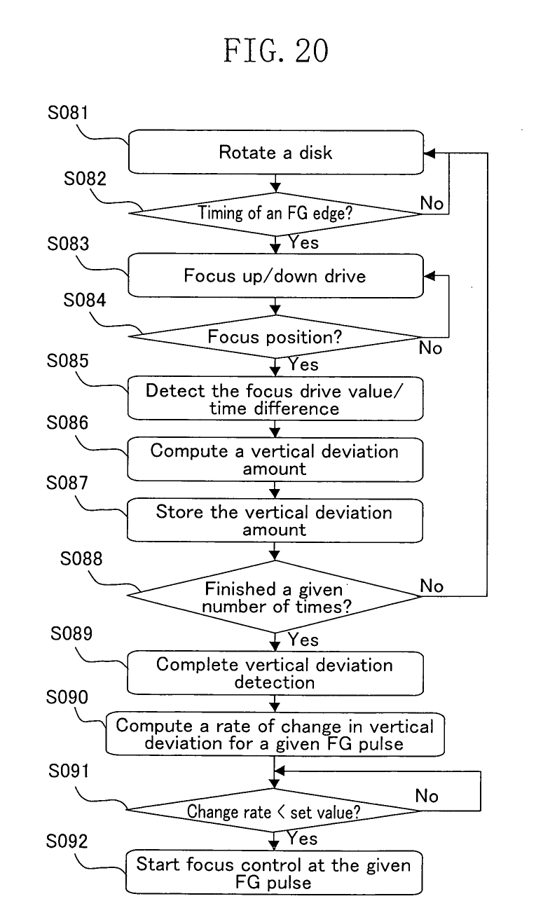

Focus control methods in Embodiment 9 of the present invention will be described with reference to FIGS. 20 to 22. FIG. 20 shows a flowchart of a focus control method in Embodiment 9. An optical disk is rotated (S081), and whether or not it is timing of an edge of the FG signal is determined (S082). If it is determined to be timing of an edge of the FG signal, focus up/down operation is performed (S083), to detect a focus position at which the focal point of the light beam is located on the recording surface of the optical disk (S084). The focus drive value at the timing of detection of the focus position and the time difference between the timing of the edge of the FG signal and the timing of the detection of the focus position are determined (S085), to compute the vertical deviation amount (S086), and the computed vertical deviation amount is stored (S087). Whether or not the detection of vertical deviation has been made a given number of times is determined (S088). If so, the vertical deviation detection is completed (S089). The rate of the change in vertical deviation amount at a given edge of the FG signal is computed (S090), and whether or not the change rate is lower than a set value is determined (S091). Focus control is started at the given edge of the FG signal if the change rate is determined lower (S092).

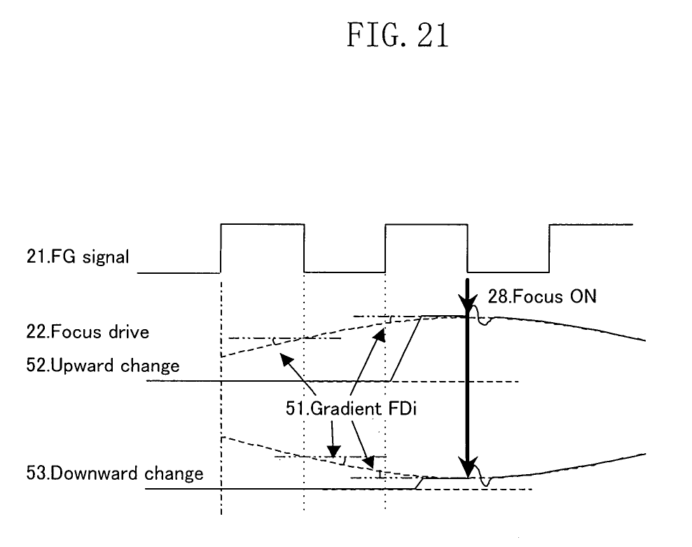

FIG. 21 shows signal waveforms related to a method for computing the timing of start of focus control according to the detected amount of change in vertical deviation amount with time. An edge of the FG signal near a portion in which the gradient FDi (51) of the focus drive value corresponding to the detected change in vertical deviation amount with time is smaller than a given set value is computed before start of focus control. The focus control is started at the timing of the computed edge of the FG signal. Since the change in vertical deviation amount with time is smaller than the set value, the focus control can be started stably.

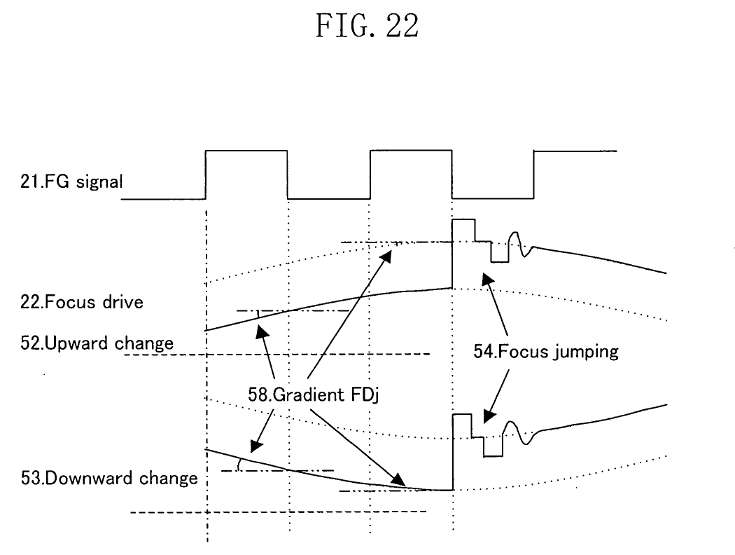

FIG. 22 shows signal waveforms related to a method for computing the timing at which stable focus jumping is secured in playback of a multilayer optical disk. Timing at which the gradient FDj (58) of the change in focus drive value 22 with time is smaller than a given set value is computed for both upward change 52 and downward change 53 of the vertical deviation amount of the optical disk, and focus jumping is executed at timing of an edge of the FG signal near the computed timing. Since the change in vertical deviation with time is smaller than a fixed value, the focus jumping can be executed stably.

### Embodiment 10

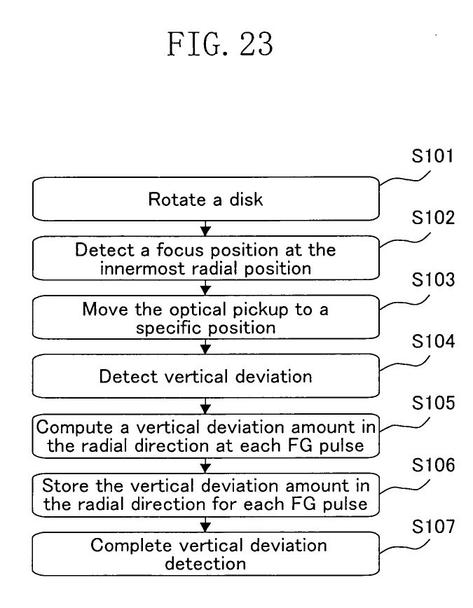

Focus control methods in Embodiment 10 of the present invention will be described with reference to FIGS. 23 to 27.

FIG. 23 shows a flowchart of a focus control method in Embodiment 10. An optical disk is rotated (S101). The optical pickup is moved to the innermost radial position, and at this position, the focus position at which the focal point of the light beam is located on the recording surface of the optical disk is detected (S102). The optical pickup is moved to a given position in the radial direction of the optical disk (S103), and at this position, the vertical deviation amount is detected by a method as that described in Embodiment 1 (S104). Based on the detected vertical deviation amount, vertical deviation amounts in the radial direction at timing of edges of the FG signal pulses are computed (S105), and the computed vertical deviation amounts are stored (S106), to complete the vertical deviation detection (S107).

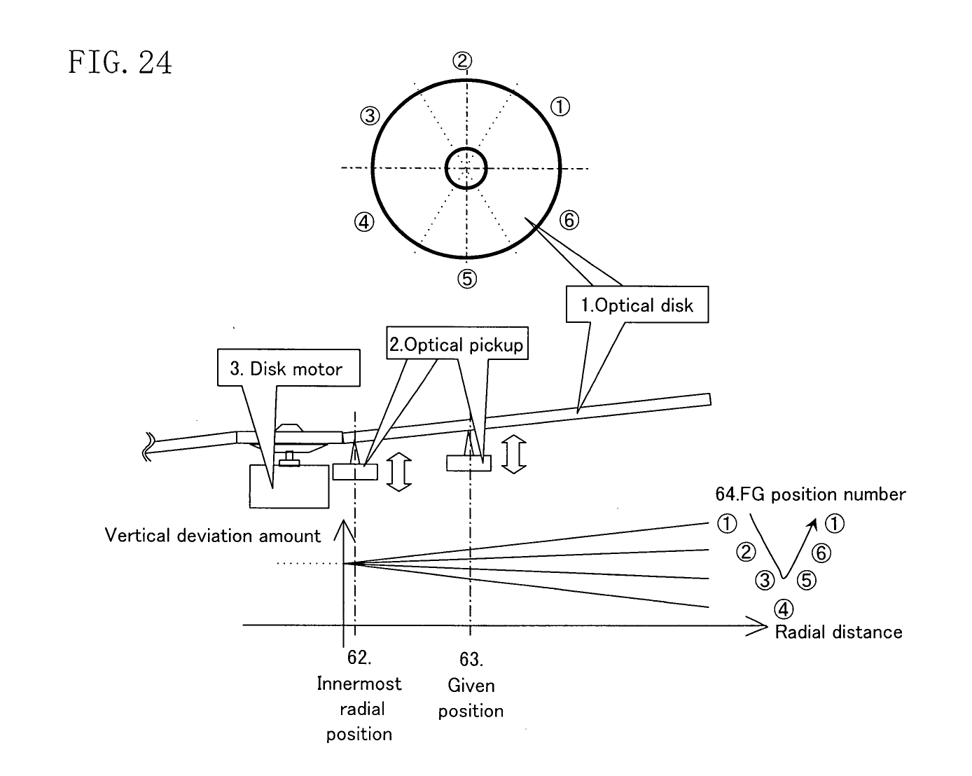

FIG. 24 is a view demonstrating the operation principle of a method for detecting the vertical deviation amount in the radial direction of the optical disk. The vertical deviation amount in the radial direction varies with the position of the optical pickup 2 in the radial direction due to the vertical deviation of the optical disk 1, and can be approximated to a linear straight line having an innermost radial position 62 as the intercept, for each of FG position numbers 1 to 6 (64) in the case that the FG signal has six pulses per rotation, with the rotation of the disk motor 3. The optical pickup 2 is moved to the innermost radial position 62 of the optical disk with an optical pickup moving means (not shown). The focus up/down operation in directions vertical to the optical disk is performed by varying the focus drive value, to detect the focus drive value at the timing at which the focal point of the light beam is located on a recording surface of the optical disk 1. The detected focus drive value is used as the vertical deviation intercept at the innermost radial position. The optical pickup 2 is then moved to a given radial position 63, and at this position, the vertical deviation amounts associated with edges of the FG signal are detected by the method described in Embodiment 1. From the vertical deviation intercept and the vertical deviation amounts detected at the given radial position 63, the vertical deviation amounts in the radial direction for the edges of the respective FG signal pulses are approximated to linear straight lines, to thereby prepare a vertical deviation table at the given radial position, and thus perform focus control.

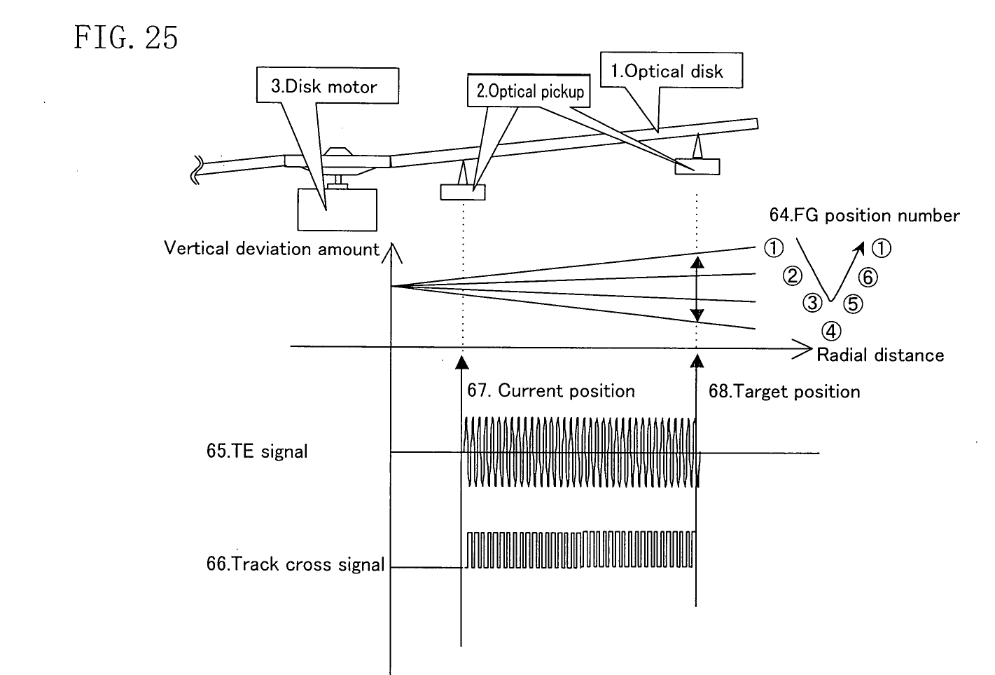

FIG. 25 is a view demonstrating the operation principle of a method for detecting the position of the optical pickup in the radial direction for computation of the vertical deviation amount of the optical disk in the radial direction. By counting the number of pulses of a TE signal 65 representing a deviation amount of the focal point of the light beam from the position of a track on the optical disk 1 on which information has been recorded, and the number of pulses of a track cross signal 66 representing that the focal point of the light beam has crossed the track, the distance of movement of the optical pickup 2 from the current position 67 to a target position 68 is determined, and from the movement distance, the vertical deviation amount in the radial direction at the target position is computed by the method shown in FIG. 18. The computed value is applied as the focus drive value. Since the actual distance of movement of the optical pickup is computed, stable focus control is secured even during the movement.

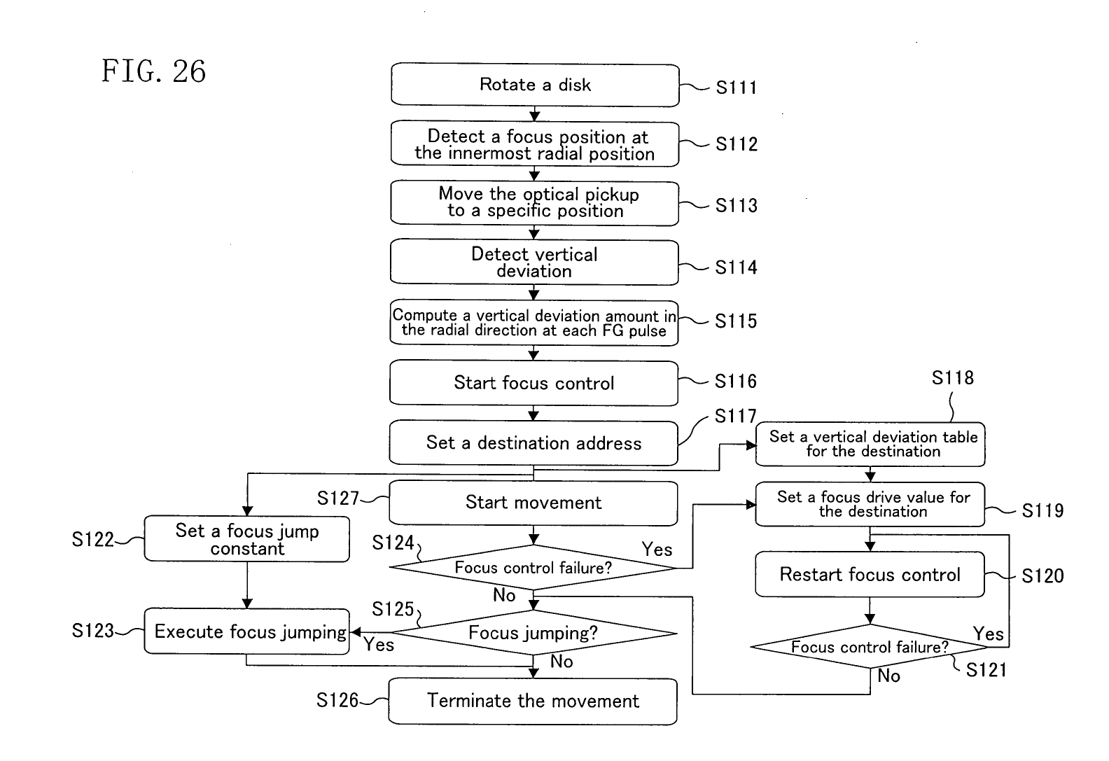

FIG. 26 is a flowchart of a method for computing the vertical deviation amount in the radial direction of the optical disk using the address of the destination position. An optical disk is rotated (S111). The optical pickup is moved to the innermost radial position, and the focus drive value at timing at which the focal point of the light beam is located on the recording surface of the optical disk is detected (S112), to use the detected value as the vertical deviation intercept at the innermost radial position. The optical pickup is moved to a given position in the radial direction (S113), and the vertical deviation amount is detected by the method described in Embodiment 1 (S114). The vertical-deviation amounts in the radial direction for the respective FG signal pulses are computed from the vertical deviation intercept and the vertical deviation amount at the given position (S115). Using the computed values, focus control is started (S116). The destination address is set for playback of data at a given position on the optical disk (S117), to start the movement (S127). At the setting of the address of the destination (S117), a vertical deviation table is prepared by computing vertical deviation amounts in the radial direction in association with the FG signal pulses from the destination address (S118), and the focus drive value is set according to the vertical deviation table (S119). Also, the focus jump constant, such as the peak value or the pulse drive time of the acceleration pulse or the deceleration pulse for focus jumping, is set (S122). If focus control is failed (S124), the focus control is restarted with the value set in the step (S119) of setting the focus drive value at the destination (S120), and this is repeated until normal focus control is resumed (S121). If focus jumping is involved during the movement (S125), the focus jumping is executed with the value set in the step (S122) of setting the focus jump constant at the destination (S123), and the movement is terminated (S126). In this way, the vertical deviation amounts in the radial direction in association with the FG signal pulses can be obtained from the destination address in an easy manner.

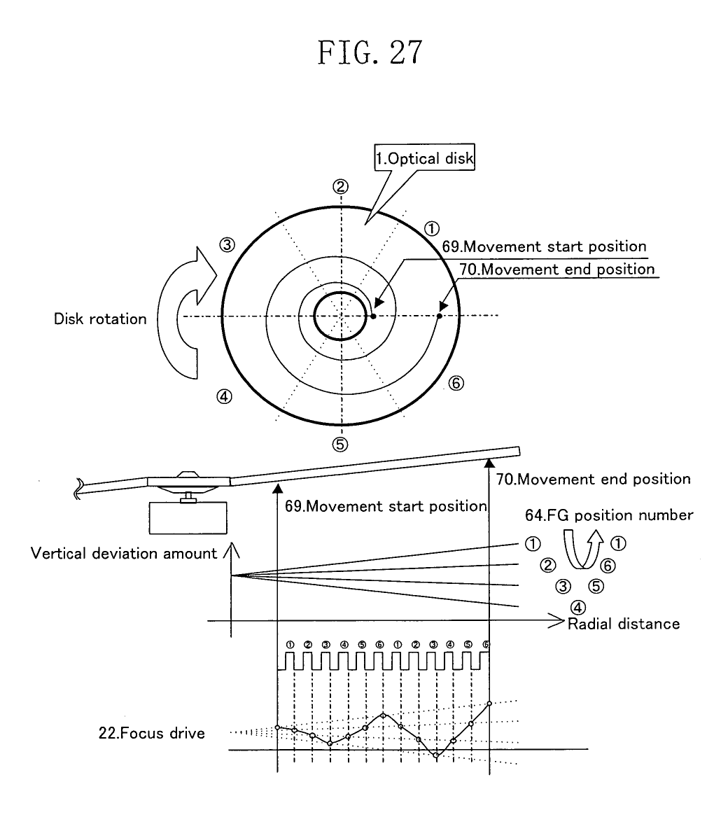

FIG. 27 shows signal waveforms related to a method for detecting the vertical deviation amount in the tangential direction and the vertical deviation amount in the radial direction simultaneously during the movement of the optical pickup for playback of information on the optical disk. A given address on the optical disk is determined as the start position 69 of movement of the light beam, and the movement is made until a movement end position 70. Since the optical disk is rotated, the vertical deviation amount in the radial direction changes with the FG position number (64) from 1 to 6 assigned to the FG signal pulses. When the rotation of the optical disk is sufficiently fast compared with the speed of the movement of the focal point, the focal point of the light beam follows a spiral path, scanning two or more positions in the radial direction for each FG position number (64). The focus control is under operation during the movement. Therefore, by detecting the focus drive values under the focus control in association with edges of the FG signal, the vertical deviation amounts in the radial direction and in the tangential direction at a given edge of the FG signal are computed. In this way, the vertical deviation amounts in the radial direction and in the tangential direction can be detected during the movement, and thus the detection time can be shortened.

### Embodiment 11

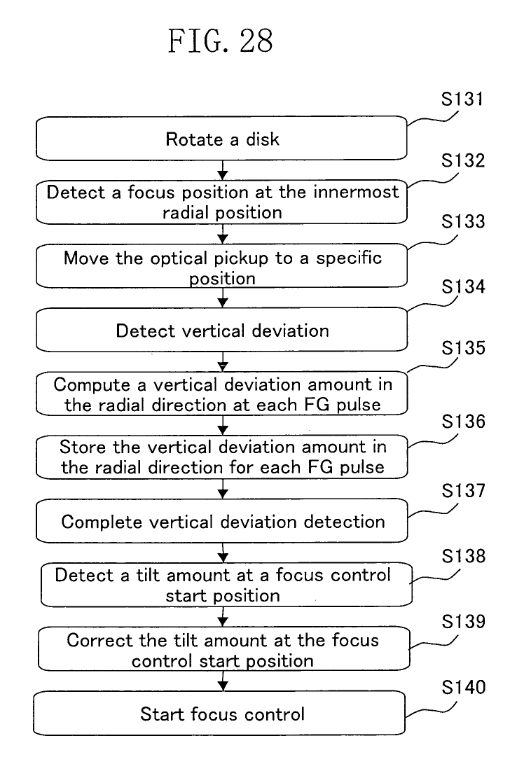

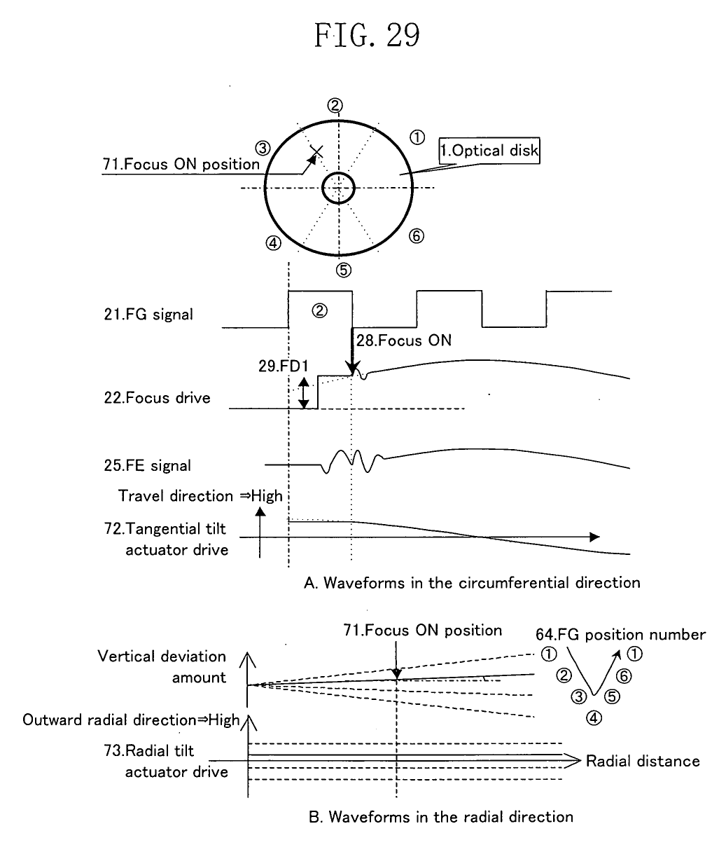

A focus control method in Embodiment 11 of the present invention will be described with reference to FIGS. 28 and 29. FIG. 28 is a flowchart of the focus control method in Embodiment 11. An optical disk is rotated (S131). The optical pickup is moved to the innermost radial position, and the focus position at which the focal point of the light beam is located on the recording surface of the optical disk is detected (S132). The optical pickup is moved to a given position in the radial direction of the optical disk (S133), and the vertical deviation amount is detected by the method described in Embodiment 1 (S134). The vertical deviation amounts in the radial direction at timing of edges of the FG signal are computed based on the detected vertical deviation amount (S135), and the computed vertical deviation amounts are stored (S136), to complete the vertical deviation detection (S137). The tilt amount at the position at which focus control is to be started is computed (S138), and the tilt amount of the optical pickup is corrected according to the computed tilt amount (S139). The focus control is then started (S140).

FIG. 29 shows signal waveforms in the tangential direction A and in the radial direction B related to a method for computing tilt amounts from the detected vertical deviation amounts to control the tilt amounts of the optical pickup. The tilt amounts of the optical pickup in the radial direction and in the tangential direction of the optical disk at a given focus ON position 71 on the optical disk are computed in advance, and a tangential tilt actuator drive value 72 is controlled for the tilt amount in the tangential direction of the optical pickup, or a radial tilt actuator drive value 73 is controlled for the tilt amount in the tangential direction of the optical pickup, and then focus control started. Thus, by correcting a tilt that may be generated due to the vertical deviation amount in the tangential direction or in the radial direction before the start of focus control, the focus control can be started more stably. Stable focus control can also be obtained by comparing the tilt amount in the tangential direction or the tilt amount in the radial direction detected for each edge of the FG signal with a given set value individually, and starting the focus control at timing at which at least the tilt amount in the tangential direction or the tilt amount in the radial direction is smaller than the given set value.

### Embodiment 12

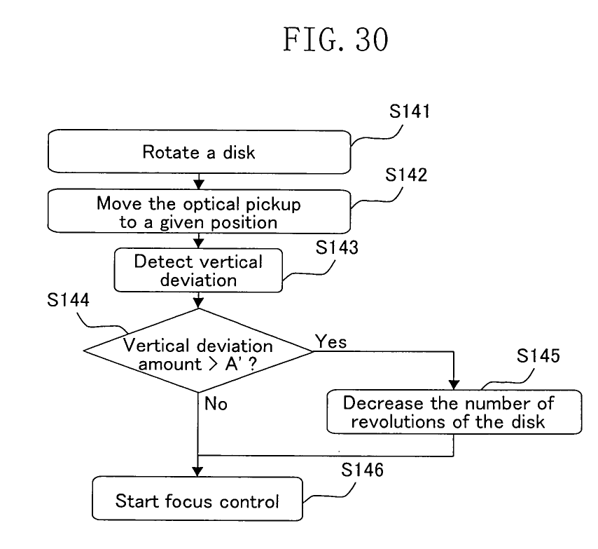

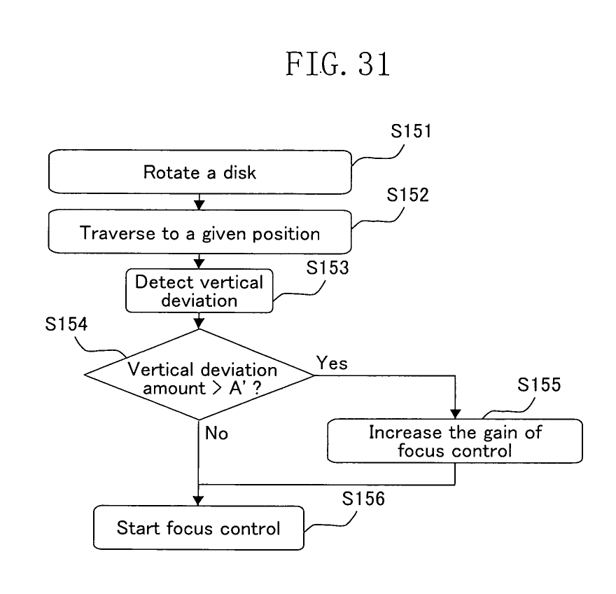

A focus control method in Embodiment 12 will be described with reference to FIGS. 30 and 31.

FIG. 30 is a flowchart of a method for reducing the speed of playback of an optical disk as measures to be taken when the maximum of the detected vertical deviation amount exceeds a given set value. An optical disk is rotated (S141), and the optical pickup is moved to a given position (S142). The vertical deviation amount at the destination is detected (S143) by the method described in Embodiment 1, and the maximum of the vertical deviation amount is compared with a given set value (S144). If the maximum is greater than the set value, the playback speed of the optical disk is reduced (S145), and then focus control is started (S146). Since the vertical deviation amount is detected before the start of focus control, it is possible to start the focus control after reducing the playback speed in advance in playback of an optical disk having a vertical deviation amount greater than a given set value. This can shorten the startup time.

FIG. 31 is a flowchart of a method for increasing the control gain of focus control as measures to be taken when the maximum of the detected vertical deviation amount exceeds a given set value. An optical disk is rotated (S151), and the optical pickup is moved to a given position (S152). The vertical deviation amount at the destination is detected (S153) by the method described in Embodiment 1, and the maximum of the vertical deviation amount is compared with a given set value (S154). If the maximum is greater than the set value, the control gain of the focus control is increased (S155), and then focus control is started (S156). Since the vertical deviation amount is detected before the start of focus control, the control gain can be increased in playback of an optical disk having a vertical deviation amount greater than a given set value, to thereby enable stable start of the focus control.

### Embodiment 13

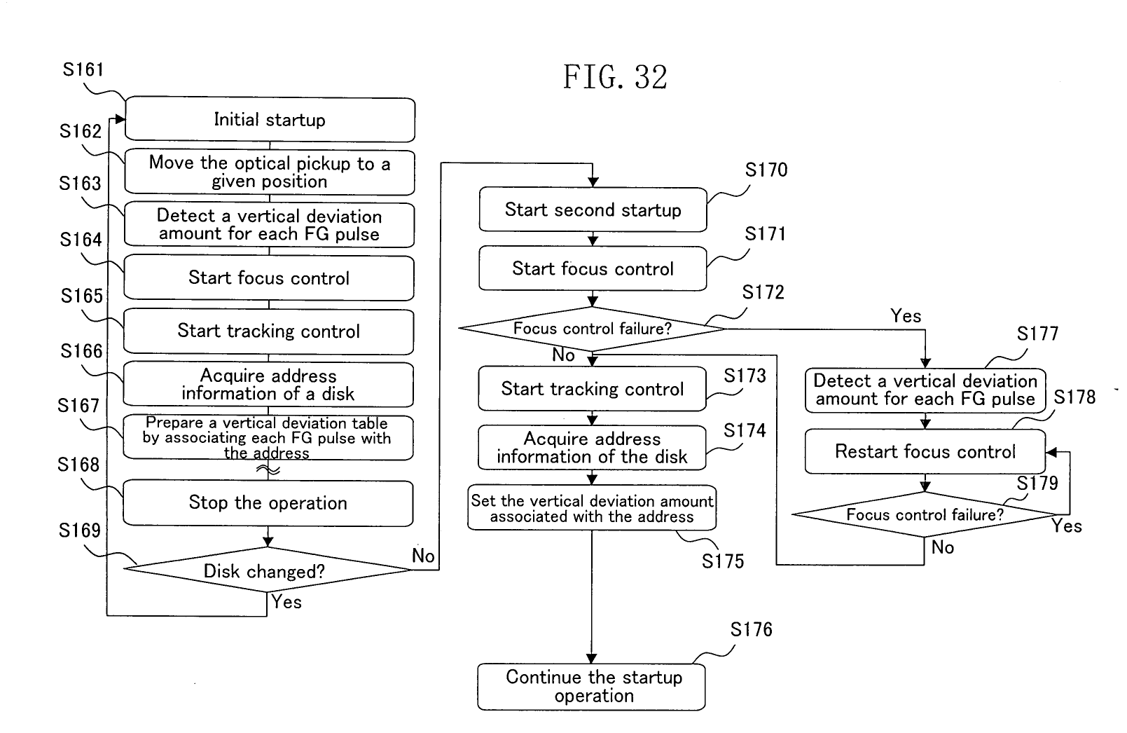

A focus control method in Embodiment 13 of the present invention will be described with reference to FIGS. 32 to 34.

FIG. 32 is a flowchart of a method for detecting the vertical deviation amount of an optical disk in association with FG signal pulses and performing subsequent focus control in association with the address on the optical disk. Initial startup is started (S161), and the optical pickup is moved to a given position (S162). The vertical deviation amount at the destination is detected (S163) by the focus control method in Embodiment 1. Focus control is started based on the detected vertical deviation amount (S164). Tracking control is performed to allow the focal point of the light beam to follow a track on the optical disk (S165), and address information on the optical disk is acquired (S166). The vertical deviation amount of the optical disk detected in association with FG signal pulses is associated with the acquired address information, to thereby prepare an address-associated vertical deviation table (S167). The operation of the device is stopped after the series of operations have been done (S168). Whether or not the optical disk has been changed is determined (S169). If changed, the initial startup is performed (S161). If not, the second startup is started (S170), and focus control is performed (S171). Whether or not the focus control is operating normally is determined (S172). If operating normally, tracking control is performed (S173), to acquire an address on the optical disk (S174). An address-associated vertical deviation table is set based on the acquired address (S175) and is used in subsequent focus control, to thereby shorten the second and subsequent startup times. If defocusing occurs in the second startup, the vertical deviation amount is detected for each FG signal pulse as described in Embodiment 1 (S177), the focus control is restarted (S178), and whether or not the focus control is operating normally is determined (S179). If not operating normally, the focus control is restarted.

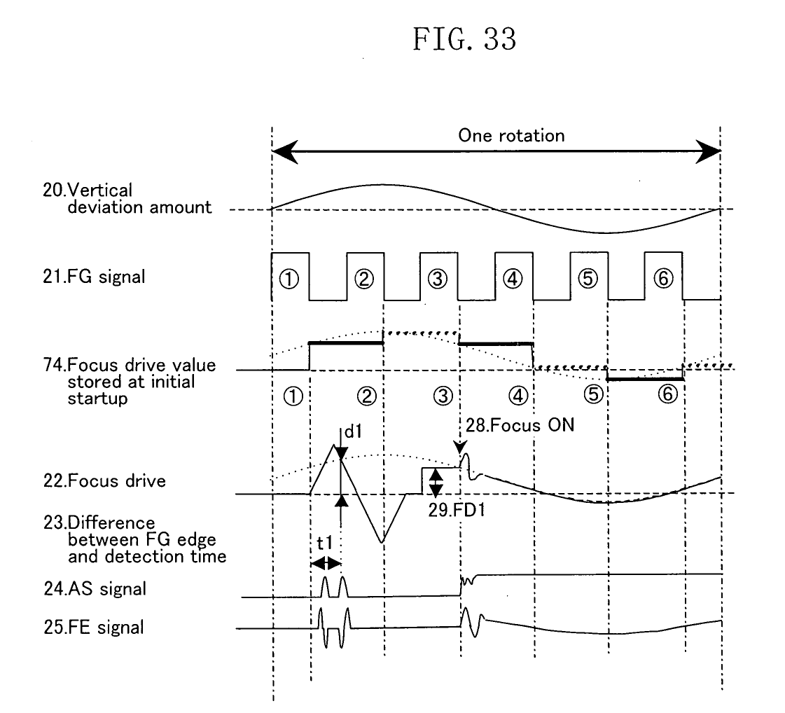

FIG. 33 shows signal waveforms related to a method for associating the vertical deviation amount detected at the initial startup with FG signal pulses at the second and subsequent startups. The focus up/down drive is performed once at the second and subsequent startups, to detect the timing at which the focal point of the light beam passes though the recording surface of the optical disk from the AS signal or the S-shaped signal of the FE signal. The focus drive value at the detected timing is detected, and is associated with the vertical deviation amount detected at the initial startup with respect to edges of the FG signal. The focus control is then started using the associated vertical deviation amount. Thus, the startup time can be shortened in the second and subsequent startup operations.

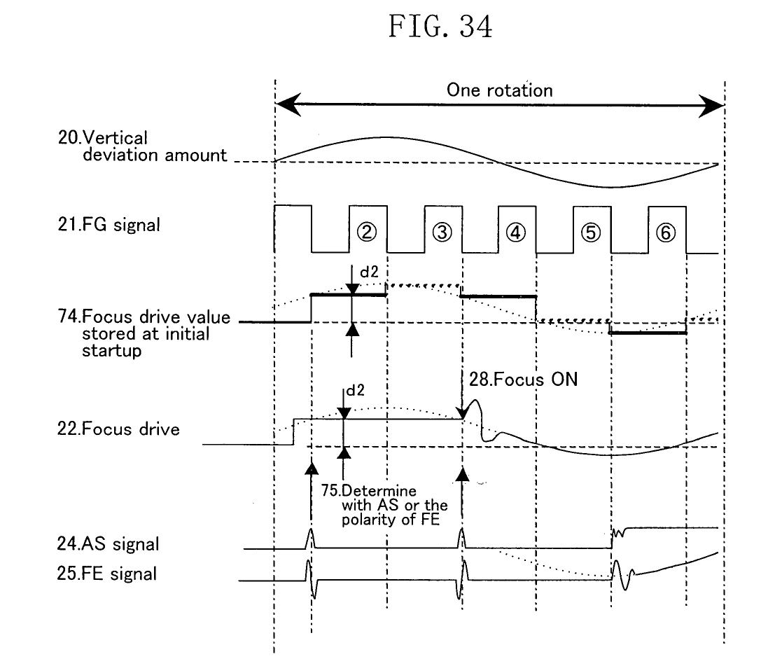

FIG. 34 shows signal waveforms related to a method for reducing the power consumption and shortening the startup time in the second and subsequent startup operations. A focus drive value associated with a given FG signal pulse is extracted from the vertical deviation amount associated with the FG signal pulses detected at the initial startup, and the extracted focus drive value is applied at the second and subsequent startups. From the polarity of an S-shaped signal of the FE signal generated when a recording surface of the optical disk has crossed the focal point of the light beam during rotation of the optical disk having the vertical deviation and the focus drive value obtained at this crossing, it is possible to associate the vertical deviation table prepared at the initial startup with edges of the FG signal. In this way, shortening of the startup time at the second and subsequent startups can be attained with low power consumption.

As described above, the focus control methods according to the present invention have the function of detecting the vertical deviation amount of an optical disk with rotation of the optical disk before start of focus control, and thus is applicable to optical disk drives permitting high-speed playback and the like.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

1. A focus control method for an optical disk device, the optical disk device comprising:
focus drive means for moving an optical pickup in a direction vertical to a recording surface of an optical disk, the optical pickup irradiating the optical disk with a converged light beam for playback of the optical disk and having a plurality of light receiving elements for receiving reflected light from the optical disk and converting the received light to an electric signal;
spindle drive means for rotating the optical disk;
rotational angular velocity detection means for detecting the rotational angular velocity from an FG signal detecting the rotational angle of the optical disk rotated by the spindle drive means;
focus position detection means for detecting that the focal point of the converted light beam is located on a recording surface of the optical disk;
focus drive value detection means for detecting a drive value output from the focus drive means at given timing;
focus detection time measurement means for measuring the time difference between a given edge of the FG signal detecting the rotational angular velocity of the optical disk and the timing of the detection of the focus position by the focus position detection means;
vertical deviation computation means for computing a vertical deviation amount for each FG signal pulse in one rotation of the optical disk using the focus drive value obtained by the focus drive value detection means and the measured result obtained by the focus detection time measurement means; and
vertical deviation amount storage means for storing the vertical deviation amount of the optical disk obtained by the vertical deviation computation means in association with an edge of the corresponding FG signal pulse,
the focus control method comprising the steps of:
performing focus up/down drive for the optical pickup, while rotating the optical disk, at timing of a given edge of the FG signal detecting the rotational angular velocity three or more times in one rotation, the focus up/down drive including driving the optical pickup in directions vertical to the optical disk to be closer to and then farther from the optical disk, or to be farther from and then closer to the optical disk, in a sequential pattern;
detecting the focus drive value at focus timing at which the focal point of the light beam is located on a recording surface of the optical disk;
measuring a focus detection time as the time difference between the timing of the given edge of the FG signal and the focus timing;
computing the vertical deviation amount in one rotation of the optical disk using the focus drive value at the focus timing and the focus detection time;
storing the computed vertical deviation amount; and
performing focus control according to the stored vertical deviation amount so that the focal point of the light beam is roughly located on the recording surface of the optical disk.

2. The method of claim 1, further comprising the steps of:
detecting the maximum of a focus summation signal obtained by summing a plurality of signals obtained from the plurality of light receiving elements of the optical pickup;
detecting the maximum and minimum of a focus error signal representing a difference in the distance between the focal point of the light beam and a recording surface of the optical disk; and
detecting the maximum of an RF envelope signal for holding a peak value of an RF signal made of a plurality of frequencies including data recorded on the optical disk,
wherein at least one of the step of detecting the maximum of a focus summation signal, the step of detecting the maximum and minimum of a focus error signal, and the step of detecting the maximum of an RF envelope signal is used for the detection of the focus position at which the focal point of the light beam is located on the recording surface of the optical disk.

3. The method of claim 1, further comprising the step of:
outputting, as the focus drive value, such a signal that updates a focus drive value corresponding to the vertical deviation amount computed and stored for each edge of the FG signal output according to the rotational angular velocity of the optical disk, every edge of the FG signal.

4. The method of claim 1, further comprising the step of:
outputting a focus drive value corresponding to the vertical deviation amount computed and stored for each edge of the FG signal output according to the rotational angular velocity of the optical disk, in a form approximated to a sine wave over a given FG signal pulse and the next FG signal pulse.

5. The method of claim 1, further comprising the step of:
changing the amount of change in focus drive value per unit time with the length of time between edges of the FG signal.

6. The method of claim 1, further comprising the steps of:
performing the focus drive for the optical pickup in a direction vertical to the optical disk to be closer to the optical disk; and
setting the amount of change in focus drive value per unit time and the amount of change in focus drive value per unit time in driving of the optical pickup farther from the optical disk, at individual given values.

7. The method of claim 1, further comprising the steps of:
computing and storing the vertical deviation amount associated with edges of the FG signal during one rotation of the optical disk;
setting the focus drive value stored for a given edge of the FG signal as the focus drive value in advance before the given edge of the FG signal; and
starting the focus control at timing of the given edge of the FG signal.

8. The method of claim 1, further comprising the steps of:
computing and storing the vertical deviation amount associated with edges of the FG signal during one rotation of the optical disk;
setting the amount of change in the focus drive value output from the focus drive means per unit time to be mildly approximated to the amount of change in focus drive value per unit time stored for a given edge of the FG signal; and
starting focus control at timing of the given edge of the FG signal.

9. The method of claim 1, wherein the optical disk device further comprises:
focus control drive value detection means for detecting the focus drive value for each FG signal pulse while performing focus control for keeping the distance between the focal point of the light beam and a recording surface of the optical disk constant, and
the method further comprises the steps of:
determining whether or not the difference between the focus drive value corresponding to the vertical deviation amount of the optical disk computed and stored before the focus control and the focus drive value corresponding to the vertical deviation amount of the optical disk detected during the focus control is greater than a given set value; and
performing subsequent focus control using the vertical deviation amount detected during the focus control if the difference between the vertical deviation amount detected before the focus control and the vertical deviation amount detected during the focus control is greater than the given set value.

10. The method of claim 1, wherein the optical disk device further comprises:
focus jump means for outputting an acceleration signal or a deceleration signal for shifting the focal point of the light beam from a given layer to a layer other than the given layer in playback of an optical disk having a plurality of layers, a given peak value and a given drive time of the acceleration signal or the deceleration signal being set by the focus drive means, and
the method further comprises the step of:
changing at least one of the peak value and the drive time of at least one of the acceleration signal and the deceleration signal in the focus jump means according to the vertical deviation amount of the optical disk computed and stored for each edge of the FG signal.

11. The method of claim 10, further comprising the step of:
setting the focus drive value so that the amount of change in focus drive value per unit time is mildly approximated to the amount of change in vertical deviation per unit time with rotation of the optical disk computed for each edge of the FG signal, before start of the focus control for a given layer of the optical disk having a plurality of layers, to which the optical pickup has been moved by the focus jump means.

12. The device of claim 1, further comprising the steps of:
suspending the focus control temporarily when the optical pickup is moved from a given layer to a layer other than the given layer for playback of an optical disk having a plurality of layers;
setting the focus drive value for a given edge of the FG signal according to the vertical deviation amount of the optical disk computed and stored for each edge of the FIG signal for the destination layer; and
restarting the focus control for the destination layer at timing of the given edge of the FG signal.

13. The method of claim 1, wherein the optical disk device further comprises:
vertical deviation change amount computation means for computing the amount of change in focus drive value per unit time with rotation of the optical disk from the vertical deviation amount of the optical disk computed and stored for each edge of the FG signal, and
the method further comprises the steps of:
computing the timing of an edge of the FG signal at which the amount of change in the vertical deviation amount of the optical disk per unit time is equal to or less than a given value; and
starting the focus control at the timing of the computed edge of the FG signal.

14. The method of claim 1, further comprising the step of:
performing focus jumping of moving the optical pickup from a given layer to a layer other than the given layer when the amount of change in vertical deviation amount per unit time is smaller than a given value in playback of an optical disk having a plurality of layers.

15. The method of claim 1, wherein the optical disk device further comprises:
optical pickup moving means for moving the optical pickup in the radial direction of the optical disk, and
the method comprises the steps of:
moving the optical pickup to the innermost radial position of the optical disk;
performing focus up/down drive for the optical pickup in a direction vertical to the optical disk to be closer to or farther from the optical disk at the innermost radial position of the optical disk;
detecting the focus drive value at timing at which the focal point of the light beam is located on a recording surface of the optical disk;
moving the optical pickup to a given position by the optical pickup moving means;
detecting the vertical deviation amount for each edge of the FG signal at the destination position;
detecting the focus drive value corresponding to the detected vertical deviation amount; and
computing the vertical deviation amount for each edge of the FG signal with respect to the position of the optical pickup in the radial direction.

16. The method of claim 15, wherein the optical disk device further comprises:
track crossing detection signal for detecting that the focal point of the light beam has crossed a track of the optical disk on which information has been recorded, and
the method further comprises the steps of:
moving the optical pickup in the radial direction of the optical disk; and
computing the vertical deviation amount of the optical disk in the radial direction for each edge of the FG signal using a track crossing signal.

17. The method of claim 15, further comprising the steps of:
moving the optical pickup in the radial direction of the optical disk; and
computing the vertical deviation amount of the optical disk in the radial direction for each edge of the FG signal from the address of the destination to which the optical pickup is moved.

18. The method of claim 15, further comprising the steps of:
moving the optical pickup in the radial direction of the optical disk;
detecting the focus drive value while performing the focus control for each edge of the FG signal; and
computing the vertical deviation amount of the optical disk in the radial direction using the detected value.

19. The device of claim 1, wherein the optical disk device further comprises:
tangential tilt drive means for operating to change a tilt of the optical pickup in the radial direction of the optical disk; and
radial tilt drive means for operating to change a tilt of the optical pickup in the radial direction of the optical disk, and
the method further comprises the steps of:
computing a tilt amount of the optical disk in the rotational direction or the radial direction at a given position of the optical pickup in the radial direction at a given edge of the FG signal;
changing the drive value of at least either the tangential tilt drive means or the radial tilt drive means based on the computed value; and
performing the focus control.

20. The method of claim 1, further comprising the steps of:
computing the timing of an edge of the FG signal at which the tilt amount of the optical disk in the circumferential direction or the radial direction is smaller than a given set value, from the vertical deviation amount of the optical disk detected and stored for each edge of the FG signal or for each position in the radial direction; and
starting the focus control at the computed edge of the FG signal.

21. The method of claim 1, wherein the optical disk device further comprises:
focus control gain change means for changing a focus control gain; and
optical disk playback speed change means for changing the playback speed of the optical disk, and
the method further comprises the steps of:
determining whether or not the difference between the maximum and minimum of the detected and stored vertical deviation amount of the optical disk is greater than a given set value; and
at least increasing the focus control gain in the focus control or decreasing the playback speed of the optical disk if the difference is determined greater.

22. The method of claim 1, further comprising the steps of:
performing focus up/down drive for the optical pickup once at timing of a given edge of the FG signal while rotating the optical disk when the operation of the device is temporarily suspended and the second and subsequent startups are performed without changing the optical disk; and
associating the focus drive value at the detected focus position with the stored vertical deviation amount for each edge of the FG signal.

23. The method of claim 1, wherein the optical disk device further comprises;
address vertical deviation detection means for associating the vertical deviation amount of the optical disk detected and stored for each edge of the FG signal with an address read from the optical disk, and
the method further comprises the steps of:
associating the vertical deviation amount with address information acquired from the optical disk when the operation of the device is temporarily suspended and the second and subsequent startups are performed without changing the optical disk; and
performing the focus control using the focus drive amount corresponding to the associated vertical deviation amount.

24. The method of claim 1, further comprising the steps of:
selecting a vertical deviation amount associated with a given edge of the FG signal, among the vertical deviation amount detected and stored in association with edges of the FG signal during first startup, when operation of the device is temporarily suspended and the second and subsequent startups are performed without changing the optical disk;
applying a focus drive amount corresponding to the selected vertical deviation amount to the optical pickup;
detecting a focus drive value at focus timing at which the focal point of the light beam is located on a recording surface of the optical disk detected during rotation of the optical disk; and
associating the detected focus drive value with the stored vertical deviation amount for each edge of the FG signal.

25. A focus control method for an optical disk device, the optical disk device comprising:
focus drive means for moving an optical pickup in a direction vertical to a recording surface of an optical disk, the optical pickup irradiating the optical disk with a converged light beam for playback of the optical disk and having a plurality of light receiving elements for receiving reflected light from the optical disk and converting the received light to an electric signal;
spindle drive means for rotating the optical disk;
rotational angular velocity detection means for detecting the rotational angular velocity from an FG signal detecting the rotational angle of the optical disk rotated by the spindle drive means;
focus position detection means for detecting that the focal point of the converted light beam is located on a recording surface of the optical disk;
focus drive value detection means for detecting a drive value output from the focus drive means at given timing;
focus detection time measurement means for measuring the time difference between a given edge of the FG signal detecting the rotational angular velocity of the optical disk and the timing of the detection of the focus position by the focus position detection means;
vertical deviation computation means for computing a vertical deviation amount for each FG signal pulse in one rotation of the optical disk using the focus drive value obtained by the focus drive value detection means and the measured result obtained by the focus detection time measurement means; and
vertical deviation amount storage means for storing the vertical deviation amount of the optical disk obtained by the vertical deviation computation means in association with an edge of the corresponding FG signal pulse,
the focus control method comprising the steps of:
changing the focus drive value at timing of a given edge of the FG signal with a given amount of change with time in a direction allowing the optical pickup to be closer to the optical disk;
holding the focus drive value once the focus drive value reaches a given set value until the next edge of the FG signal;
changing the focus drive value at timing of the next edge of the FG signal with a given amount of change with time in a direction allowing the optical pickup to be farther from the optical disk;
holding the focus drive value once the focus drive value reaches a given set value until the further next edge of the FG signal;
performing the above steps alternately thereafter at timing of edges of the FG signal, to detect the vertical deviation amount of the optical disk from the focus drive values detected at the focus positions in association with the corresponding edges of the FG signal; and
performing focus control according to the detected vertical deviation amount.

26. A focus control method for an optical disk device, the optical disk device comprising:
focus drive means for moving an optical pickup in a direction vertical to an optical disk, the optical pickup irradiating the optical disk with a converged light beam and having a plurality of light receiving elements for receiving reflected light from the optical disk and converting the received light to an electric signal;
spindle drive means for rotating the optical disk;
rotational angular velocity detection means for detecting the rotational angular velocity from an FG signal detecting the rotational angle of the optical disk rotated by the spindle drive means;
focus summation signal maximum detection means for determining the maximum of a focus summation signal obtained by summing a plurality of signals obtained from the plurality of light receiving elements of the optical pickup;
focus summation signal time measurement means for measuring the time during which the focus-summation signal is greater than a given value;
focus error extreme detection means for determining the maximum and minimum of a focus error signal representing a difference in the distance between the focal point of the light beam and a recording surface of the optical disk;
focus error extreme shift time measurement means for measuring the time of the shift of the focus error signal from the maximum to the minimum or the time of the shift from the minimum to the maximum;
RF envelope signal maximum detection means for detecting the maximum of an RF envelope signal for holding an amplitude value of an RF signal made of a plurality of frequencies including information recorded on the optical disk,
RF envelope signal time measurement means for measuring the time during which the RF envelope signal is greater than a given value;
focus position detection means for detecting that the focal point of the converted light beam is located on a recording surface of the optical disk;
vertical deviation change rate detection means for detecting the relative rate of the amount of change with time in the vertical deviation amount changing with rotation of the optical disk to the amount of change with time in the focus drive value output from the focus drive means at given timing using at least one of the focus summation signal time measurement means, the focus error extreme shift time measurement means and the RF envelope signal maximum detection means;
focus drive value detection means for detecting the drive value output from the focus drive means at given timing;
focus position detection time measurement means for measuring the time difference between a given edge of the FG signal used in the rotational angular velocity detection means and the timing of the detection of the focus position by the focus position detection means;
vertical deviation computation means for computing a vertical deviation amount for each FG signal pulse in one rotation of the optical disk using the focus drive value obtained by the focus drive value detection means, the output from the vertical deviation change rate detection means and the result obtained by the focus position detection time measurement means; and
vertical deviation amount storage means for storing the vertical deviation amount of the optical disk obtained by the vertical deviation computation means in association with edges of the FG signal,
the focus control method comprising the steps of:
performing focus up/down drive for the optical pickup, while rotating the optical disk, at timing of a given FG signal pulse output in synchronization with the rotation of the optical disk two or more times per rotation, the focus up/down drive including driving the optical pickup in directions vertical to the optical disk to be closer to and then farther from the optical disk, or to be farther from and then closer to the optical disk, in a sequential pattern;
detecting the focus drive value at focus timing at which the focal point of the light beam is located on a recording surface of the optical disk and also detecting the vertical deviation change rate with rotation of the optical disk at detection timing of the focus position detected during at least one sequential operation among the two or more times of the focus up/down drive;
computing the vertical deviation amount in one rotation of the optical disk using the time difference between the timing of a given edge of the FG signal and the focus timing;
storing the computed vertical deviation amount; and
performing focus control according to the stored vertical deviation amount so that the focal point of the light beam is roughly located on the recording surface of the optical disk.

27. A focus control method for an optical disk device, the optical disk device comprising:
focus drive means for moving an optical pickup in a direction vertical to a recording surface of an optical disk, the optical pickup irradiating the optical disk with a converged light beam and having a plurality of light receiving elements for receiving reflected light from the optical disk and converting the received light to an electric signal; and
focus error polarity detection means for detecting whether an S-shaped signal of a focus error signal output when the focal point of the light beam passes through a recording surface of the optical disk changes from the maximum to the minimum or from the minimum to the maximum,
the focus control method comprising the steps of:
driving the optical pickup in a direction vertical to the optical disk to be closer to or farther from the optical disk;
detecting the polarity of the S-shaped signal of the focus error signal generated when the focal point of the light beam passes through a recording surface of the optical disk; and
determining the number of recording surfaces of the optical disk from the polarity of a given number of S-shaped signals of the focus error signal detected.

28. The method of claim 27, wherein the optical disk device further comprises:
focus summation signal maximum detection means for determining the maximum of a focus summation signal obtained by summing a plurality of signals obtained from the plurality of light receiving elements of the optical pickup;
focus error extreme detection means for determining the maximum and minimum of the focus error signal representing a difference in the distance between the focal point of the light beam and a recording surface of the optical disk;
RF envelope signal maximum detection means for detecting the maximum of a signal for holding a peak value of an RF signal made of a plurality of frequencies including data recorded on the optical disk;
spindle drive means for rotating the optical disk;
rotational angular velocity detection means for detecting the rotational angular velocity from an FG signal detecting the rotational angle of the optical disk rotated by the spindle drive means;
focus drive value detection means for detecting a focus drive value output from the focus drive means at given timing;
focus position detection time measurement means for measuring the time difference between a given edge of the FG signal used in the rotational angular velocity detection means and the timing of the detection of the focus position by the focus position detection means;
vertical deviation computation means for computing a vertical deviation amount for each FG signal pulse in one rotation of the optical disk using the focus drive value obtained by the focus drive value detection means and the result obtained by the focus position detection time measurement means; and
vertical deviation amount storage means for storing the vertical deviation amount of the optical disk obtained by the vertical deviation computation means in association with edges of the FG signal, and
the focus control method further comprises the steps of:
performing focus up/down drive for the optical pickup, while rotating the optical disk, at timing of a given edge of the FG signal three or more times per rotation, the focus up/down drive including driving the optical pickup in directions vertical to the optical disk to be closer to and then farther from the optical disk in a sequential pattern;
computing the vertical deviation amount for each detected recording surface using the focus drive value detected at the focus timing at which the focal point of the optical beam is located on a recording surface of the optical disk and the time difference between the timing of the given edge of the FG signal and the focus timing;
storing the computed vertical deviation amount in association with edges of the FG signal; and
performing focus control for each layer using the stored value.

29. The device of claim 27, wherein the optical disk device further comprises:
focus S-shaped signal count means for detecting the number of S-shaped signals of the focus error signal generated when the focal point of the light beam passes through a recording surface of the optical disk, and
the focus control method further comprises the steps of:
performing focus up/down drive including driving the focus drive means to be closer to and then farther from the optical disk in a sequential pattern a given number of times per rotation;
detecting the focus drive value at timing of the first detection of a recording surface when the number of S-shaped signals having the same polarity detected in the first focus up/down drive is two or more;
detecting the difference in focus drive value between a plurality of layers of the optical disk at the second detection;
detecting the focus drive value only for a given layer of the optical disk at timing of the subsequent detections of a recording surface; and
performing focus control for each layer by adding or subtracting the difference in focus drive value between layers to or from the detected vertical deviation amount for the given layer.

30. The method of claim 27, wherein the optical disk device further comprises:
focus S-shaped signal amplitude detection means for detecting the amplitude of an S-shaped signal of the focus error signal from the difference between the maximum and minimum of the S-shaped signal, and
the focus control method further comprises the steps of:
executing addition/subtraction of a given set value, not detecting the focus drive value if a plurality of S-shaped signals having the same polarity are output continuously in the focus error signal and the amplitude of a detected S-shaped signal is smaller than a given set value; and
performing focus control for each layer using the computed value.
